(19) United States
(12) Patent Application Publication
(10) Pub. No.: US 2022/0122328 A1
(43) Pub. Date: Apr. 21, 2022

(54) SYSTEM AND METHOD FOR UPDATING OBJECTS IN A SIMULATED ENVIRONMENT

(71) Applicant: Treasured Inc., Nobleton (CA)

(72) Inventors: Vito Sergio Giovannetti, Nobleton (CA); Mikita Varabei, Maple (CA)

(21) Appl. No.: 17/427,055

(22) PCT Filed: Jan. 31, 2020
(86) PCT No.: PCT/CA2020/050120

§ 371 Date: Jul. 29, 2021

Related U.S. Application Data
(60) Provisional application No. 62/799,665, filed on Jan. 31, 2019.

(51) Int. Cl. G06T 19/00; G06T 7/70

(52) U.S. Cl. CPC G06T 19/006; G06T 7/70

(57) ABSTRACT

A system and method for providing a cloud-based interactive simulated reality environment which evolves in a multi-dimensional way over time. The system features a modular design that enables the creation, evolution, and expansion of a personalized simulated reality environment across an unlimited amount of users. More specifically, the system enables the automation of a personalized three-dimensional (3D) simulated reality environment that can transform both independently of and dependently on the user, collaborators, and visitors.

### CROSS-REFERENCE

This application claims the benefit of U.S. Provisional Patent Application No. 62/799,665, filed Jan. 31, 2019, and the entire contents of U.S. Provisional Patent Application No. 62/799,665 is hereby incorporated by reference.

### FIELD

Various embodiments are described herein that generally relate to methods and systems for updating objects in a simulated reality environment.

### BACKGROUND

Computer-based environments allow people to share information and multimedia documents without having to be within physical proximity of each other. In particular, simulated reality environments, which includes virtual reality (VR) and VR environments, enable people to interact with each other in a more realistic way so that they can engage in activities that were previously only done in person. There is a need for a simulated reality environment that allows people of varying technical abilities with the ability to engage in the simulated environment to make it easy to use and more closely resemble a real environment.

### SUMMARY OF VARIOUS EMBODIMENTS

In accordance with one aspect of the teachings herein, a system for auto-generating and modifying an evolving simulated reality environment, the system comprising: a data store; and at least one processor coupled to the data store, the at least one processor being configured to execute: an importing module that is adapted to receive multimedia content from at least one user device through a software application, and to store the multimedia content on the data store; an auto-generation module that is adapted to generate the simulated reality environment, to parse metadata in the multimedia content, and to create a priority score for the multimedia content based at least in part on predetermined rules and learned rules; and an output module to display the simulated reality environment and the multimedia content in an order in the simulated reality environment based on the priority score for each of the multimedia content.

In at least one embodiment, the software application is at least one of an internet application and a mobile application.

In at least one embodiment, the importing module is further configured to sort the received multimedia content based on a date of receipt of the content.

In another aspect, there is provided a system for providing interactions between a plurality of user devices within a simulated reality environment, the system comprising: a data store; and a processor coupled to the data store, the processor being configured to execute: an authorization module that is adapted to register an account for a first user device of the plurality of user devices, to receive access permission for the account from a simulated reality environment owner, and to identify visitation and content creation by the first user device, the content comprising at least one 3D object; a data processing module that is adapted to synchronize interactions by the first user device with evolution pathways of the simulated reality environment, to share the interactions with the simulated reality environment owner and at least one of the plurality of user devices, and to collect a unique activation of the first user device and associated behaviors with at least one of a plurality of 2D and/or 3D objects in the simulated reality environment; and an output module that is adapted to post multimedia messages and interactable objects to a central repository that influences the evolution pathways associated with the simulated reality environment.

In at least one embodiment, the output module is further adapted to send an invitation to at least one of the plurality of user devices with a custom-generated uniform resource locator or key-sensitive code.

In at least one embodiment, the output module is further adapted to create access permission to at least one of the plurality of user devices to the simulated reality environment.

In at least one embodiment, the processor is further configured to execute: an environment state module that is adapted to monitor the interactions, determine time periods between the interactions, to identify relationships between users of at least two of the plurality of user devices, and to determine and generate data points based at least in part on the interactions, the time periods between the interactions, and the relationships; an input module that is adapted to receive the data points; and an auto-generation module that is adapted to learn by machine learning changes in placement and presentation of the content within the simulated reality environment, the machine learning based at least in part on a predefined set of rules with weighted distributions for the plurality of user devices, the relationships, and the data points.

In at least one embodiment, the machine learning is further based at least in part on: extracting data relating to a location, a date/time, and identities of the plurality of user devices, the extracted data being obtained by an analysis of user submitted images, descriptions, and audio in the content; obtaining user data from the plurality of user devices relating to the location, the date/time, and the identities of the plurality of user devices; determining differences between the extracted data and the user data; analyzing a first object of a plurality of 3D objects based at least in part on mesh, texture, and 2D representation, generating a plurality of tags based on the analysis and associating the first object to a real world location, a time period, other people, and categories; grouping the extracted data and the user data, the grouping generating variables with assigned weights that determine how much similarity between different variables is needed for deciding whether or not to group content units together; and searching among the plurality of 3D objects within a grouping for a 3D object that has extracted data most closely matching a combination of the user data and the extracted data to determine search results.

In at least one embodiment, the categories comprise sports, history, science, games, popular knowledge and other relevant tags.

In at least one embodiment, the auto-generation module is further adapted to: group the 3D objects by content unit; group the content units by content group; generate group 3D coordinates for each content group; generate unit 3D coordinates for a content unit within a content group; generate object 3D coordinates for each 3D object within a content unit; and store in a database the group 3D coordinates, the unit 3D coordinates, the object 3D coordinates, the 3D objects, the extracted data, and the user data.

In another aspect, there is provided a computer-implemented method for auto-generating and modifying an evolving simulated reality environment, the method comprising: receiving multimedia content from at least one user device through a software application; storing the multimedia content on a data store; generating the simulated reality environment; parsing metadata in the multimedia content; creating a priority score for the multimedia content based at least in part on predetermined rules and learned rules; and displaying the simulated reality environment and the multimedia content in an order in the simulated reality environment based on the priority score for each of the multimedia content.

In at least one embodiment, the software application is at least one of an internet application and a mobile application.

In at least one embodiment, the method further comprises sorting the received multimedia content based on a date of receipt of the content.

In another aspect, there is provided a computer-implemented method for providing interactions between a plurality of user devices within a simulated reality environment, the method comprising: registering an account for a first user device of the plurality of user devices; receiving access permission for the account from a simulated reality environment owner; identifying visitation and content creation by the first user device, the content comprising at least one 3D object; synchronizing interactions by the first user device with evolution pathways of the simulated reality environment; sharing the interactions with the simulated reality environment owner and at least one of the plurality of user devices; collecting a unique activation of the first user device and associated behaviors with at least one of a plurality of 3D objects in the simulated reality environment; and posting multimedia messages and interactable objects to a central repository that influences the evolution pathways associated with the simulated reality environment.

In at least one embodiment, the method further comprises sending an invitation to at least one of the plurality of user devices with a custom-generated uniform resource locator or key-sensitive code.

In at least one embodiment, the method further comprises creating access permission to at least one of the plurality of user devices to the simulated reality environment.

In at least one embodiment, the method further comprises: monitoring the interactions; determining time periods between the interactions; identifying relationships between users of at least two of the plurality of user devices; determining and generating data points based at least in part on the interactions, the time periods between the interactions, and the relationships; receiving the data points; and learning by machine learning changes in placement and presentation of the content within the simulated reality environment, the machine learning based at least in part on a predefined set of rules with weighted distributions for the plurality of user devices, the relationships, and the data points.

In at least one embodiment, the machine learning is further based at least in part on: extracting data relating to a location, a date/time, and identities of the plurality of user devices, the extracted data being obtained by an analysis of user submitted images, descriptions, and audio in the content; obtaining user data from the plurality of user devices relating to the location, the date/time, and the identities of the plurality of user devices; determining differences between the extracted data and the user data; analyzing a first object of a plurality of 3D objects based at least in part on mesh, texture, and 2D representation, generating a plurality of tags based on the analysis and associating the first object to a real world location, a time period, other people, and categories; grouping the extracted data and the user data, the grouping generating variables with assigned weights that determine how much similarity between different variables is needed for deciding whether or not to group content units together; and searching among the plurality of 3D objects within a grouping for a 3D object that has extracted data most closely matching a combination of the user data and the extracted data to determine search results.

In at least one embodiment, the categories comprise sports, history, science, games, popular knowledge and other relevant tags.

In at least one embodiment, the method further comprises: grouping the 3D objects by content unit; grouping the content units by content group; generating group 3D coordinates for each content group; generating unit 3D coordinates for a content unit within a content group; generating object 3D coordinates for each 3D object within a content unit; and storing in a database the group 3D coordinates, the unit 3D coordinates, the object 3D coordinates, the 3D objects, the extracted data, and the user data.

It should be noted that in at least one of the above-noted embodiments and the embodiments in the detailed description, the simulated reality environment is one of a VR environment, a mixed 2D and 3D environment, and an Augmented Reality (AR) environment.

Other features and advantages of the present application will become apparent from the following detailed description taken together with the accompanying drawings. It should be understood, however, that the detailed description and the specific examples, while indicating preferred embodiments of the application, are given by way of illustration only, since changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a system diagram including a server for generating a dynamic simulated reality environment.

FIG. 1B is a block diagram of an example embodiment of the system server of FIG. 1A.

FIG. 1C is a block diagram of an example embodiment of the containers of the system server.

FIG. 2 is an example embodiment of a method of creating a dynamic simulated reality environment.

FIG. 3 is an example embodiment of a system for displaying 2D content in a dynamic simulated reality environment.

FIG. 4 is an example embodiment of a system for displaying 3D content in a dynamic simulated reality environment.

FIG. 5 is an example embodiment of a method of triggering audio in a dynamic simulated reality environment.

FIG. 6 is an example embodiment of a method of including data flow for constructing a dynamic simulated reality environment.

FIG. 7 is an example embodiment of a system for deployment of a dynamic simulated reality environment.

FIGS. 8A and 8B are example embodiments of methods of including data flow for customizing a dynamic simulated reality environment based on multimedia and social data.

FIG. 9 shows an example embodiment of a method of including data flow for performing voice transcription in a dynamic simulated reality environment.

FIG. 10 shows an example embodiment of a method of displaying and interacting with multimedia content in a 3D simulated reality environment.

FIG. 11 shows an example embodiment of a method of modifying a 3D environment to show evolution of the 3D simulated reality environment.

FIG. 12 shows an example embodiment of a method of managing navigation in a 3D simulated reality environment.

FIG. 13 shows an example embodiment of a method of managing collaboration in a 3D simulated reality environment.

FIG. 14 shows a screenshot of an example of a first building exterior view from a simulated reality environment.

FIG. 15 shows a screenshot of an example of a building interior view from a simulated reality environment.

FIG. 16 shows a screenshot of an example of a second building exterior view from a simulated reality environment.

FIG. 17 shows a screenshot of an example of a third building exterior view from a simulated reality environment.

FIG. 18 shows a screenshot of an example of a first interactive garden memorial view in a simulated reality environment.

FIG. 19 shows a screenshot of an example of a second interactive garden memorial view in a simulated reality environment.

FIG. 20 shows a screenshot of an example of a third interactive garden memorial view prior to flower blossoming in a simulated reality environment.

FIG. 21 shows a screenshot of an example of a fourth interactive garden memorial view after flower blossoming in a simulated reality environment.

FIG. 22 shows a screenshot of an example of an interactive tree memorial view after planting in a simulated reality environment.

FIG. 23 shows a screenshot of an example of the interactive tree memorial view after watering in a simulated reality environment.

FIG. 24 shows a screenshot of an example of the interactive tree memorial view after full growth in a simulated reality environment.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling can have an electrical connotation. For example, as used herein, the terms coupled or coupling can indicate that two elements or devices can be directly connected to one another or connected to one another through one or more intermediate elements or devices via an electrical signal, electrical connection, one or more virtual objects, or communication pathway depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

The embodiments of the systems and methods described herein may be implemented in hardware or software, or a combination of both. These embodiments may be implemented in computer programs executing on programmable computers, each computer including at least one processor, a data store or data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device, or any other computing device capable of being configured to carry out the methods described herein.

In at least one embodiment herein, a communication interface is included to allow for communication between devices and between a user and the devices that are hosting the Virtual Reality (VR) environment. The communication interface may be a network communication interface. In some embodiments, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output data. The output data may be applied to one or more output devices. Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium that stores various computer programs, that when executed by a computing device, causes the computing device to operate in a specific and predefined manner to perform at least one of the functions described in accordance with the teachings herein.

Furthermore, the system, processes, and methods of the described embodiments are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage media, as well as transitory forms such as, but not limited to, wireline transmissions, satellite transmissions, internet transmission or downloads, digital and analog signals, and the like. The computer useable instructions may also be in various forms, including compiled and non-compiled code.

The current practice for providing a virtual reality (VR) environment is to provide an interactive computer-generated experience using a virtual reality headset or by a three-dimensional (3D) rendering on a two-dimensional (2D) monitor. The VR environment includes realistic images or sounds to simulate a person's physical presence in a particular scene or setting. The person can look around the scene, move around in it, and interact with virtual objects in it. As such, the VR environment includes one or more of special purpose computers for performing certain functions and processing, non-transitory computer-readable media, and electronic devices (e.g., VR goggles).

Various applications of VR have arisen in such fields as entertainment, education, health care, engineering, and art exhibition. Each of these applications has its own technical challenges, and the VR environments created for those applications require technical solutions to make the simulations realistic. However, the VR environments described in accordance with the teachings herein has its own set of technical challenges as it is a multi-user VR environment that can evolve over time, such as a VR memorial.

It should be noted that although the example embodiments described herein apply to and are described in the context of VR memorials, this is done for illustrative purposes, and it should be understood that these example embodiments can apply equally to other VR environments in which, for example, multiple users of varying technical abilities are involved in the generation, participation, updating, and/or viewing of the VR environment. Some examples of such VR environments include, but are not limited to, a memorial, a wedding, an anniversary, a graduation, a birthday, and retirement, for example.

Alternatively, or in addition, the example embodiments described herein may apply to other types of simulated reality environments other than pure VR environments such as, but not limited to, 2D monitors, mixed environments (e.g., both 2D monitors and 3D goggles), and Augmented Reality (AR) environments. Accordingly, portions of the description which discuss the generation and/or operation of the system with respect to VR environments apply to the other simulated reality environments. The various environments may be implemented using one or more of a personal computer (PC), a gaming console, a mobile device, a VR device, an AR device, a brain computer interfaces (BCI), or other device or combination of devices that allow similar inputs and outputs.

Referring to the challenge of providing a dynamic VR environment (e.g., a virtual memorial) that simulates a dynamic real-life environment (e.g., a physical memorial), there are several technical challenges: including one or more of (1) customization—how to customize a 3D VR environment from a 2D web interface; (2) association—how to associate owner-uploaded content with a VR environment layout and a set of 3D objects where the content is synchronized between the VR environment, web interface, and content management system; (3) optimization—how to automatically optimize the grouping of owner-uploaded media in the 3D environment as well as adjust the positioning and interaction with multimedia and assets in the 3D environment; and (4) evolution—how to manage content item evolution that is influenced by creator interactions and multi-user engagement.

In accordance with the teachings herein, the example embodiments that are described provide technical solutions to one or more of these challenges. For the first challenge related to customization, in at least one embodiment, a creation order form (e.g. a creation order graphical user interface) in a web-based application is used, where users can upload and suggest multimedia objects that they want placed in specific sections of the 3D environment. The creation order form/user interface can follow a multi-step process and can be re-submitted by the user for additional requested revisions to the 3D environment. The front-end layout of the creation order form/user interface can be custom-made. The back-end connections of the imported media include various types of media such as, but not limited to, photos, videos, and audio files, for example, and can be set up to custom endpoints.

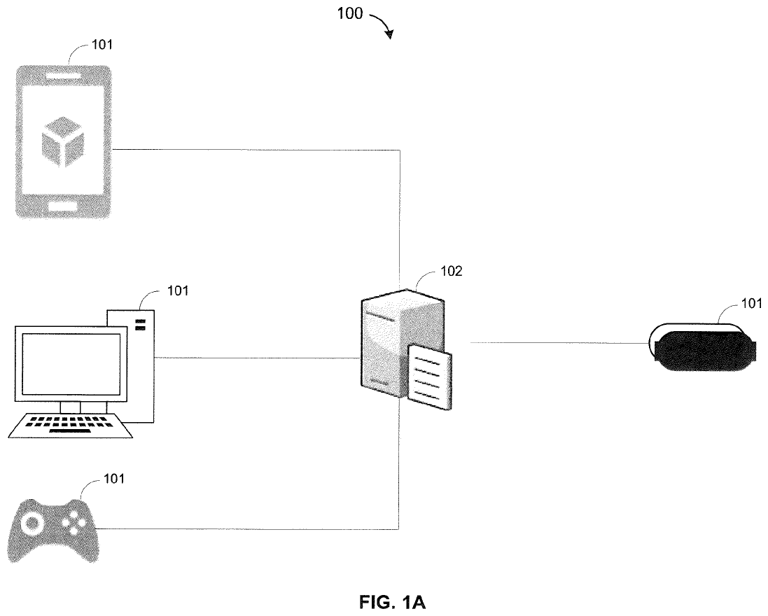

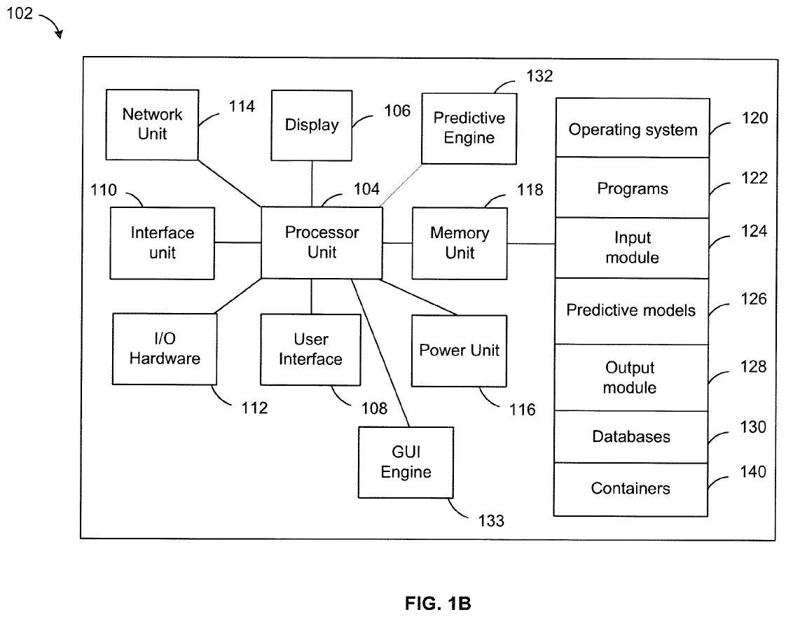

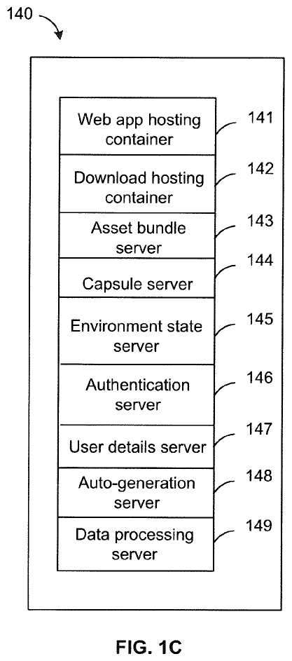

For the second challenge related to association, some example embodiments described herein provide a microservice architecture having certain components such as, but not limited to, five components: including an asset bundle server, a capsule server, an environment state server, a user information server, and an authentication server, for example. These servers are described below in relation to FIG. 1C.

For the third challenge related to optimization, at least one example embodiment described herein provides a system that looks at the available data on user uploaded content, and performs various operations on the content. It groups the content by date, then in the sub-groups by location, personal relationships, keywords, and other relevant factors. The system also keeps track of owner modifications to the generated groups and subgroups in order to collect data for training a machine learning based approach to grouping content. These groups and sub-groups are then used to position the content within the 3D environment. The system then searches for 3D content that is relevant to a specific group in order to automate the addition of 3D objects to the section of the simulated reality environment where that group is placed. The method for grouping the content based on the key data points can be custom made. Open source libraries can be used to analyze the images to extract additional data, but the association of the data can be custom tailored. Tagging and classifying 3D objects can be implemented in addition, as well as the search to associate 3D objects to content groups based on relevance.

For the fourth challenge related to evolution, at least one example embodiment described herein provides an evolution engine that manages creator interactions and multi-user engagement. Creator interactions include, for example, the addition, modification, or viewing of 3D objects in the VR environment. The evolution engine tracks all user interactions with the VR environment, such as, but not limited to, which users visit the VR environment, their relationships to each other and to the owner, how much time has passed since the creation of the VR environment, the passage of special events, the date/time of the current visit, frequency of visits, and other relevant information. Based on the frequency of visits from various users, the VR environment visibly ages; for example, it begins to gather dust and cobwebs, and looks gloomier. Once the VR environment is in such a state, users can unlock a new option to improve the VR environment into a more lively state when they visit. Users can also have special interactions given on special events, such as Christmas or the birthday of a person who is the focus of the memorial. The environment state server keeps track of how many users are in the VR environment at once (i.e. at the same time), and their relationships; for example, if the environment state server determines that a lot of close family members are gathered in the VR environment at once, the environment state server can trigger a special event. This special event can lead to previously unavailable interactions with the VR environment such as, but not limited to, adding permanent decorations to the VR environment that were previously unavailable, and creating a permanent virtual landmark to commemorate the unique special event. In at least one implementation, all of this data can be stored on the environment state server, with some user interaction data such as, but not limited to, users leaving comments, can be stored on the capsule server. The data may include, for example, when users visit the museum, if they visited during special events, how many users gathered together at a given time, and how much time has passed since users last visited.

In at least one embodiment, based on the age of the VR environment and interaction with users, content units within the VR environment may be also rearranged, and older seldom interacted with content units may be moved to an archive section automatically. A content unit is a data structure that includes at least one of, for example: image(s), video(s), audio file(s), a description, and the metadata about the content unit, such as location, date/time, categorization, tags, and connections to people. Content units in some cases allow a user to submit comments and/or multimedia related to an aspect of the VR environment or in response to content submitted by another user. A content group is a collection of content units. The system may place content units into content groups in a way where there is a close relationship between the extracted data points on each content unit.

In at least one embodiment, the owner and administrator of the VR environment are also able to specify the types of reactions and emotions they want to evoke through the VR environment. In such cases, the VR environment may be modified by adjusting the positioning and presentation of virtual content based on feedback from user interactions to better accomplish the desired goal of certain types of reactions and emotions from users that interact with the VR environment. A user (e.g., a visitor to the VR environment) can directly make changes to the groupings and 3D objects presented through a web or mobile interface. The user can also set goals through the web and/or mobile interface, and the auto-generation server takes that into consideration for the weights when generating the VR environment.

Reference is first made to FIG. 1A, showing an example embodiment of a system 100 that allows a user to interact with a dynamic VR environment. Various types of (electronic) user devices 101, such as a cell phone, desktop computer, gaming console, or VR headset, can be used by a user to access the system 100. A system server 102 can communicate with all of the user devices 101 that access the system 100. The system server 102 can be a single physical server (i.e., one computer) or a distributed server (e.g., multiple networked computers). The system server 102 can run one or more microservices as modules on a single computer or across multiple computers. Each of the microservices may be referred to as a server itself and/or by its function. For example, a module that provides information on the state of the dynamic VR environment may be referred to as a “state server” when implemented by one or more servers that are specialized to perform this function. Alternatively, the term “state module” may be used when a single computing device provides this functionality as well as other functionality for the microservices. The dynamic VR environment can be deployed in whole or in part on the system server 102.

Referring now to FIG. 1B, shown therein is a block diagram of an example embodiment of the system server 102. The system server 102 may run on a single computer, including a processor unit 104, a display 106, a user interface 108, an interface unit 110, input/output (I/O) hardware 112, a network unit 114, a power unit 116, and a memory unit (also referred to as “data store”) 118. In other embodiments, the system server 102 may have more or less components but generally functions in a similar manner.

The processor unit 104 may include a standard processor, such as the Intel Xeon processor, for example. Alternatively, there may be a plurality of processors that are used by the processor unit 104 and these processors may function in parallel. The display 106 may be, but not limited to, a computer monitor, a VR headset (or VR goggles), mixed reality goggles, a mobile phone, a tablet device, or a gaming console. The user interface 108 may be an Application Programming Interface (API) or a web-based application that is accessible via the network unit 114. The network unit 114 may be a standard network adapter such as an Ethernet or 802.11x adapter.

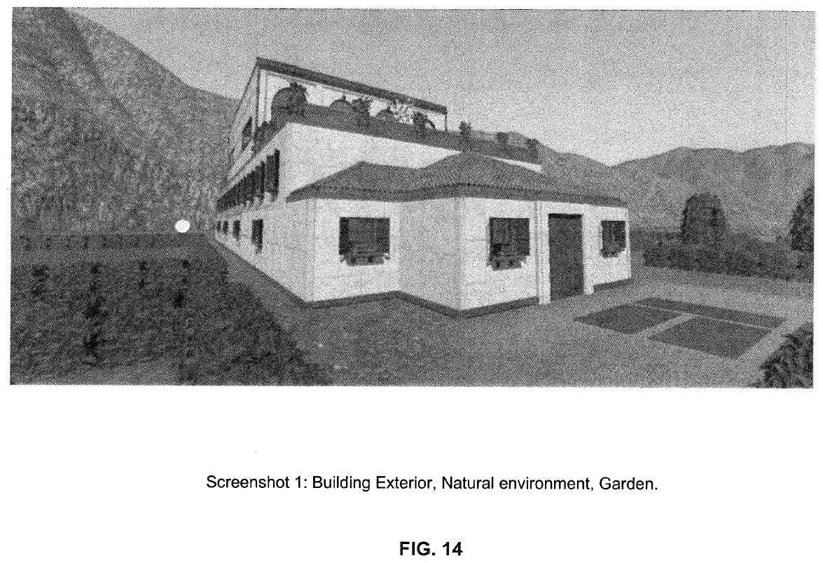

The processor unit 104 may execute a predictive engine 132 that functions to provide predictions by using predictive models 126 stored in the memory unit 118. The processor unit 104 can also execute a graphical user interface (GUI) engine 133 that is used to generate various GUIs, some examples of which are shown (e.g. VR environments shown in FIGS. 14 to 24) and described herein. The GUI engine 133 provides data according to a certain layout for each user interface and also receives inputs from a user. The GUI then uses the inputs from the user to change the data that is shown on the current user interface or shows a different user interface.

The memory unit 118 may store the program instructions for an operating system 120, program code 122 for other applications, an input module 124, a plurality of predictive models 126, an output module 128, and databases 130. The predictive models 126 may include, but are not limited to, image recognition and categorization algorithms based on deep learning models and other approaches, Natural Language Processing algorithms focused on extracting information from text, Audio processing algorithms, and Geometric Machine Learning for 3D objects processing.

The programs 122 comprise program code that, when executed, configures the processor unit 104 to operate in a particular manner to implement various functions and tools for the dynamic VR environment.

The input module 124 may provide for the parsing of the objects and the parsing of the plurality of object metadata. The input module 124 may provide an API for image data and image metadata. The input module 124 may store input in a database 130.

The input module 124 may also serve as an importing module, which can receive multimedia content, such as through a web page, for example, store the multimedia content on the memory unit 118, and sort the multimedia content based on a date of receipt of the content. The processor unit 104 may then store the content on the content server. The input module 124 may also provide an interface for a user device 101 to submit content units to match 3D objects to.

The output module 128 may post the multimedia content in a certain order and/or location in the VR environment based on a priority score for each of the multimedia content. The output module 128 may be used by the processor unit 104 to send an invitation to the user devices 101 with a custom-generated uniform resource locator (URL) or key-sensitive code, create access permission for one of the user devices 101, and post text (or multimedia) messages and interactable gifts to a central repository (such as the database 130) that influences the evolution pathways associated with the VR environment.

The databases 130 may store a plurality of historical virtual objects, a plurality of image metadata, the plurality of predictive models 116 where each predictive model having a plurality of virtual object features, input data from the input module 124, and output data from the output module 128. The determined features can later be provided if a user is visually assessing a virtual object and they want to see a particular feature. The databases 130 may also store the various scores and indices that may be generated during assessment of at least one virtual object. In at least one embodiment, all or at least some of this data can be used for continuous training. In such embodiments, if features are stored, then updated predictive models (e.g., from continuous training activities) may also be applied to existing features without the need to re-compute the features themselves, which is advantageous since feature computation is typically a very computationally intensive component.

The system server 102 may be implemented as a cluster (e.g., a Kubernetes cluster) of various computers split using containers 140 (e.g., Docker containers). Alternatively, or in addition, the containers 140 can all reside on the memory unit 118 of the system server 102. Accordingly, the containers 140 may be modules on the system server 102 or servers in a cluster. Each of the containers 140 may be stored on separate computers (which may themselves be servers).

Referring now to FIG. 1C, shown therein is a block diagram of an example embodiment of the containers 140. These containers (also called “modules” or “servers”) can manage the various parts of the 3D VR environment (also called “environment”). One container is a web app hosting container 141, which may include, for example, a web creation tool, a web environment, and a dashboard. Another container is a download hosting container 142 for the environments. Further containers 140 include the various servers that run different modules: an asset bundle server 143, a capsule server 144, an environment state server 145, an authentication server 146, a user details server 147, an auto-generation server 148, and a data processing server 149.

The asset bundle server 143 stores various data including asset bundles and performs various functions such as updating game files. This allows efficient updates of the user's 3D object files and reuse of the same assets across multiple environments stored on the same computer to reduce storage requirements and load times. The asset bundles may contain grouped objects that are very often used together, and the grouping of these objects within the asset bundles can be updated over time to improve efficiency. The updates to the asset bundles can be guided by administrator actions, and by statistics gathered from the VR environment. The asset bundle server 143 may be implemented as an asset bundle module (e.g., running on the same computer as other modules).

The capsule server 144 can store various data such as, but not limited to, the contents of picture frames, associated descriptions, audio files, and additional comments, for example. The additional comments can take the form of comments input by the users or metadata. For example, 3D stands are the same as picture frames, except they have an association to a 3D virtual object from an asset bundle. In at least one implementation, every time a VR environment is launched, the system server 102 checks for changes from the capsule server 144 to update the media, descriptions, and comments. The capsule server 144 may be implemented as a capsule module (e.g., running on the same computer as other modules).

Every time a VR environment is launched, the system server 102 may check for changes from the capsule server to update the media, descriptions, and comments. Alternatively, or in addition, a client-side application residing on the user device 101 may send requests to the system server 102 to check for changes. The environment state server 145 keeps track of the age of the VR environment, the last visited user, the frequency and total count of visits, and other information relevant to the state of the VR environment. This supports the VR environment's ability to evolve over time. The user information server performs various functions such as, but not limited to, tracking user-specific data, relationships between users, user's biography, age, gender, personal preferences, and identifying characteristics.

The environment state server 145 performs various functions such as, but not limited to, tracking the age of the environment, the last visited user, the frequency and total count of user visits, and other data relevant to the state of the environment. This supports the VR environment's ability to evolve over time. The environment state server 145 can monitor interactions between user devices 101, determine time periods between the interactions, identify relationships between the users of the user devices 101, and determine and generate data points based on the interactions, the time periods between the interactions, and the relationships. The environment state server 145 may be implemented as an environment state module (e.g., running on the same computer as other modules).

The authentication server 146 performs various functions such as, but not limited to, allowing users to log in and store other user-specific information. The authentication server 146 can register an account on a user device 101, receive access permission for the account from a VR environment owner, and/or identify visitation and content creation by the user device 101. The content that is created may include one or more 3D virtual objects. The authentication server performs various tasks including allowing users to log in, secure multiple devices, view sessions, and control other relevant authorization information related to the user. The user device 101 can view from a single dashboard what devices the user is logged in on, when the user last logged in, and other information about each user device 101. The authentication server 146 can also force logout of a specific user device 101. The authentication server 146 may be implemented as an authentication module (e.g., running on the same computer as other modules).

The user details server 147 stores various data such as, but not limited to, data about the users of the VR environment, including those input by the user, those input by an administrator, and those generated by the environment based on the user's interaction with the environment. The user details server 145 may be implemented as a user details module (e.g., running on the same computer as other modules).

The auto-generation server 148 performs various functions such as, but not limited to, automatically generating a VR environment and/or modifying placement of virtual content within the VR environment. The auto-generation server 148 can parse metadata in the multimedia content and create a priority score based on predetermined rules. The metadata can be extracted from images, description, and audio. The metadata can then be analyzed for the date/time and content location (e.g. location within the real world). The metadata and the results of the analysis can be used for matching content units together and for matching content groups to 3D objects. The auto-generation server 148 may be implemented as an auto-generation module (e.g., running on the same computer as other modules).

The auto-generation server 148 can learn, for example by machine learning, changes in placement and presentation of the content within the VR environment. The machine learning can be based on a predefined set of rules with weighted distributions for the users of the user devices 101, the relationships between the user and the VR environment, and the data points. User modifications to the environment can be used to update the weights to the machine learning models. The data points may include the data extracted from the user's multimedia and from the 3D objects. The data points include, for example, content location, date/time, relationships to other users, user mentioned in the content, tags (e.g., identification labels, category labels), and categories (e.g., sports, history, science, games, popular knowledge, or more fine grained categories, like cats).

The auto-generation server 148 can perform various functions such as, but not limited to, extracting data for machine learning, such as a content location, a date/time, and identities of the users of the user devices 101 that wish to upload content and/or visit the VR environment. The extracted data can be obtained by an analysis of the user-submitted content including, but not limited to, images, descriptions, video, and audio. The auto-generation server 148 can obtain user data directly from the user devices 101 for machine learning, such as the user location, the date/time of a user interaction with the simulated environment, and the identities of the user devices 101.

The auto-generation server 148 can perform the machine learning. The machine learning can be based on analysis of a 3D object and its mesh, texture, and 2D representation; the analysis can generate a tag and associate a 3D object to an object location and time period for the VR environment. The machine learning can be further based on grouping of the extracted data and user data, the grouping generating variables with assigned weights which are then used to determine how much similarity there is between different variables and this determined similarity then influences whether or not to group content units together. The machine learning can be used to search among the plurality of 3D objects within a grouping for a 3D object that has extracted data that most closely matches a combination of user data and extracted data. The extracted data may include, for example, content location, date/time, relationships to other users, user mentioned in the content, tags, and categories.

In an example scenario to illustrate the auto-generation server 148 in use, a user device 101 submits multiple content units. Each content unit has information about their grandfather, multiple content units talk about the grandfather being a sailor, and the time period is around the 1950's. The content units are then grouped into a “Grandfather Sailor” content group. The auto-generation server 148 finds a 3D object that has a “sailor” tag on it, and looks for objects from a similar time period (e.g., a sailor hat, a boat from the 1950's, or an anchor). The 3D object of a sailor hat is then associated with the content group. The matching is then shown on the user device 101, and the user can perform changes if they do not like what the system gave as output. The changes are recorded by the front end and sent to the auto-generation server 148 to be stored and to update the weights in the machine learning models. Once the user is satisfied with the grouping and provided objects, the content units are placed within the VR environment, and the 3D object is also placed inside the environment.

The auto-generation server 148 can perform various functions such as, but not limited to, one or more of grouping the 3D objects by content unit; grouping the content units by content group; generating group 3D coordinates for each content group; generating unit 3D coordinates for a content unit within a content group; generating object 3D coordinates for each 3D object within a content unit; and storing in a database at least one of the group 3D coordinates, the unit 3D coordinates, the object 3D coordinates, the 3D objects, the extracted data, and the user data. The group 3D coordinates may be represented by the coordinates of the content group within the VR environment, such as a point in space or the 3D boundaries of the content group. The object 3D coordinates may be represented by the coordinates of the content unit within the VR environment, such as a point in space or the 3D boundaries of the content unit.

In at least one embodiment, the user device 101 can move content units from one content group to another. This is a machine learning clustering challenge with dynamically changing cluster definitions. The edits by the user relative to the original output by the clustering model are saved and used to retrain the model for more accurate clustering. The output is the grouping of the content; the system may make a mistake or the way it decided to group the content may not be to the user's liking. The user can move content from one group to another to make edits. The user device 101 can be used by the user to change which 3D objects are associated to the content groups. This is a similar challenge to the grouping of content units. In at least one embodiment, the user edits which 3D object is used in a content group may be recorded and used to train the machine learning models. Part of the effect of these changes is adjusting the importance weights placed on the different data points such as location, date/time, and personal connections. A loss function is computed between the predicted content groups (from the machine learning algorithm (i.e., neural network implemented by predictive engine 132)) and the user-edited content groups, and also between suggested 3D objects and the user-selected 3D objects. Back-propagation is then applied to adjust the weights to make better predictions. The weights applied to these data points are not the only thing that can change over time, as the machine learning algorithm is capable of adding (e.g. stacking) many layers into a neural network to decrease the loss function. The neural network may have one or two layers to start, and then the number of layers may be increased when, for example, the hardware is scaled up.

In at least one embodiment, the auto-generation server 148 uses multimedia importing to customize VR environments using the Unity game engine. The Unity game engine can be used to render the virtual content, while the grouping, placement, and overall auto generation can be done by custom written code. The rendering first places content into logical groups, and then maps the groups onto a set of coordinates available within the virtual environment.

The data processing server 149 can perform various functions such as, but not limited to, comparing, sharing, and/or synchronizing interactions between users. For example, the data processing server 149 can synchronize interactions by a user device 101 with evolution pathways of the VR environment, share the interactions with the VR environment owner and other user devices 101, and collect unique activations of the user devices 101 and associated behaviors with at least one of the 3D objects. The data processing server 149 may be implemented as a data processing module (e.g., running on the same computer as other modules).

The evolution pathways can be a series of transitions through environment states. In an example scenario, a user device 101 creates the VR environment for a grandfather who is still alive. The user device 101 populates the environment with the grandfather's content. The grandfather passes away. A funeral is held. A sapling is placed in the environment as a symbol of the grandfather's memory. Visitors water the tree, and the tree grows with each visitor. This causes more plants to grow, tree roots spread throughout the environment, and new interactions are unlocked. Later, visitors do not come for a long time. The tree starts to wilt; the environment looks gloomier, dusty. A new visitor comes after a long time, who sees this and gets a special magical interaction to bring life back to the environment. The interaction restores the nice looking state of the museum, and the new visitor gets a special reward for keeping the memory alive.

As described previously, although the above describes various containers as servers, they may also be implemented as modules or programs on the system server 102. The modules can include program code, that when executed by the processor unit 102, may be used for independent transformation of the personalized 3D environment, dependent transformation of the environment, or semi-independent transformation.

The implementation of some or all of the servers can be custom made in whole or in part. For example, the asset bundle structure can be created by a third party, while the usage, storage, and optimizations may be custom made. Pre-created databases can be used, but the structure and management of these databases can be custom tailored and evolve over time as described in accordance with the teachings herein.

In some embodiments, semi-independent modules are included and used to perform various functions including storing in the cloud the date of the creation of the VR environment and when it was last visited. Based on these dates, the VR environment is visually updated to show aging. The VR environment can be modified to show a range of aging stages that can depend on passage of time and user interaction. The semi-independent modules are semi-independent since they cannot be entirely independent as their operation can be modified by the user, but their operation can also change the VR environment without user interaction.

In at least one embodiment, activity dependent modules are included and used to track events, track time-related data such as the aging data above, and also to track additional user interaction. For example, events can include interacting with the central memorial and leaving a message. Sending data to the cloud is possible, where the environment state server for the storage of the state of one or more VR environments, which can be collectively referred to as virtual worlds, is updated. An example of this may be a user watering the tree.

In at least one embodiment, the asset server 301 stores, as asset bundles, all the 3D objects that can be placed in a given VR environment. These assert bundles are stored and shared across VR environments, but the unique placement in each VR environment may be dependent on user interaction with the VR environment.

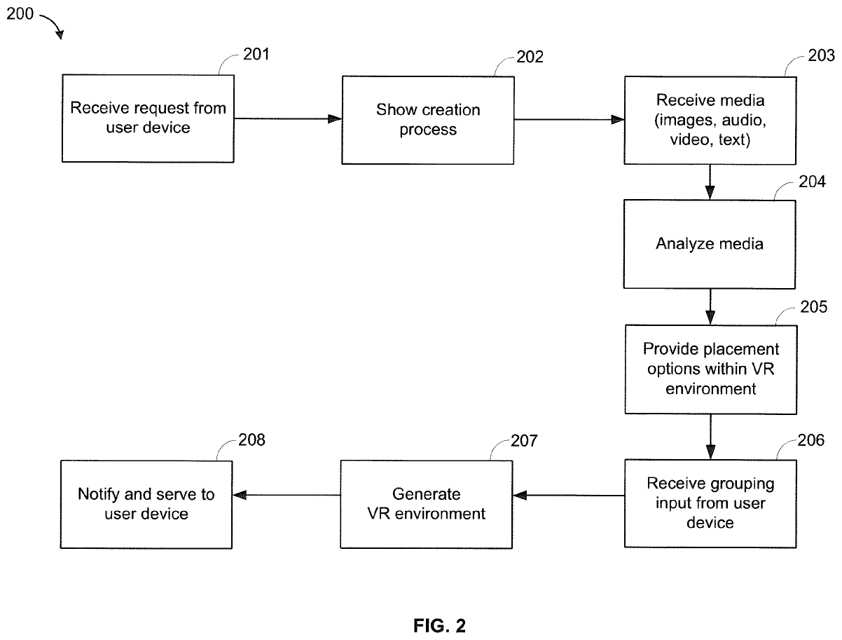

Referring now to FIG. 2, shown therein is an example embodiment of a method 200 of creating a dynamic VR environment. The method 200 can be performed by the system server 102 in FIG. 1B. For example, some or all of the acts (or blocks) of method 200 may be performed by the processor unit 104.

At act 201, the system server 102 receives a request from a user device 101 to initiate a creation process. An example of the creation process is the user device 101 uploading media to create content units through a web/mobile application.

At act 202, the system server 102 communicates with the user device 101 to show the creation process, for example, on a web browser.

At act 203, the system server 102 receives uploaded content from the user device 101 to be used in the created VR environment. This content may include images, videos, text or audio descriptions, date/time information, content location information, and audio. The content can then be analyzed to provide a suggestion of how to group the content and this suggestion is sent to the user device 101.

At act 204, the system server 102 analyzes the uploaded content (e.g., the media). The system server 102 may analyze the uploaded content using some or all of method 800 (described below), for example.

At act 205, the system server 102 provides the user, via the user device 101, with the options of following a suggested grouping of the content in the VR environment or modifying the grouping of their uploaded content. For example, the system server 102 is configured to display how the user's environment will be setup as a result of an automated algorithm, which can be the same algorithm that analyzes the content items and assigns tags to the content items. This can be done by placing all the content items using the automated algorithm, based on the assigned tags to the content items, into the simulated environment and then displaying the results for the user to view as well as displaying to the user which tags were assigned to specific items. For example, some content items that have assigned tags that are determined to be close to one another in some attribute or meaning can be placed closer to one another in the simulated environment. If the user is not satisfied, the user is provided with an option to change a location of a content item in the simulated environment, to change a grouping of content items, and/or change the tagging of the content items. Any changes the user makes may be recorded to improve the automated algorithm.

At act 206, the system server 102 receives the input data from the user device 101 (e.g. for the input described in act 205), and may also receive further uploaded content if required. This uploading may be done by providing the user with an editor/user interface that can be used to receive text files, image files, audio files, video files, and other multimedia from the user.

At act 207, the system server 102 organizes and stores the content to generate the VR environment.

At act 208, the system server 102 then provides the user device 101 with a link to download the VR environment, and serves to provide the multimedia content when the VR environment is executed.

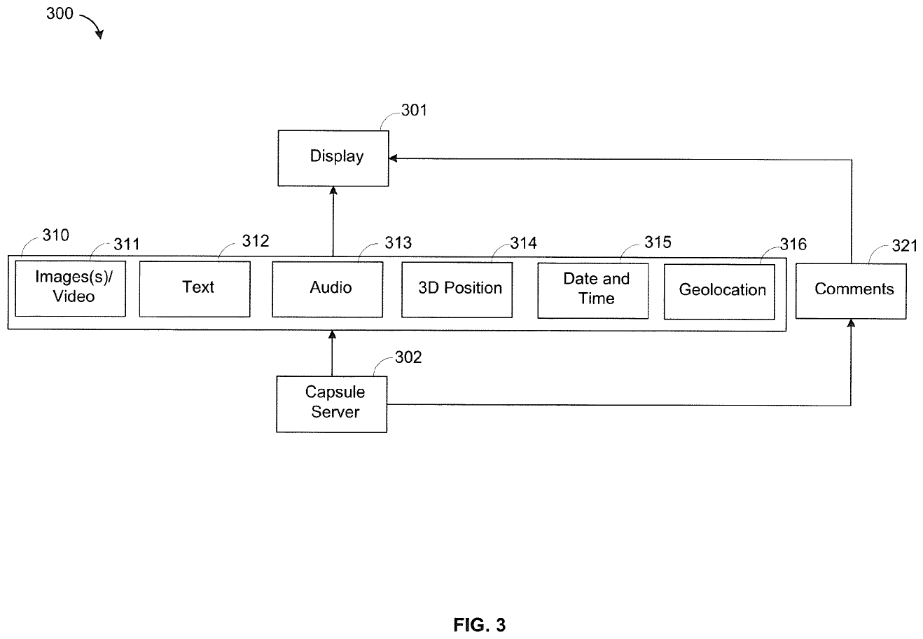

Referring now to FIG. 3, shown therein is an example embodiment of a system 300 for displaying 2D content in a VR environment. The system 300 can be managed and implemented by the system server 102 in FIG. 1B. The VR environment can be customized with the 2D content by organized the 2D content within the environment, auto-generating the 2D content, and changing aspects of the 2D objects to evolve the VR environment over time.

The system 300 provides a 2D display image 301. The 2D display 301 includes various 2D content 310. The 2D content 310 includes one or more of images/video 311, text 312, audio 313, 2D representations of 3D objects, 3D coordinates 314, a date/time 315, and a (real world) geolocation 316. The 2D display image 301 can be shown on the display 106 of the system server 102.

The 2D content 310 can be stored on and provided by a capsule server 302, which may be the capsule server 144 of the system server 102. The 2D display image 301 may also have associated comments 321. The comments 321 can change if the 2D content 310 changes. The comments 321 can also be specific to one or more of the images/video 311, text 312, audio 313, 3D coordinates 314, date/time 315, and geolocation 316 that may be included in the 2D content 310. The comments 321 can be stored on the capsule server 302. The comments 321 may be created by user devices 101 operated by visitors. The user devices 101 can leave comments from the VR environment, or from the web/mobile application interface.

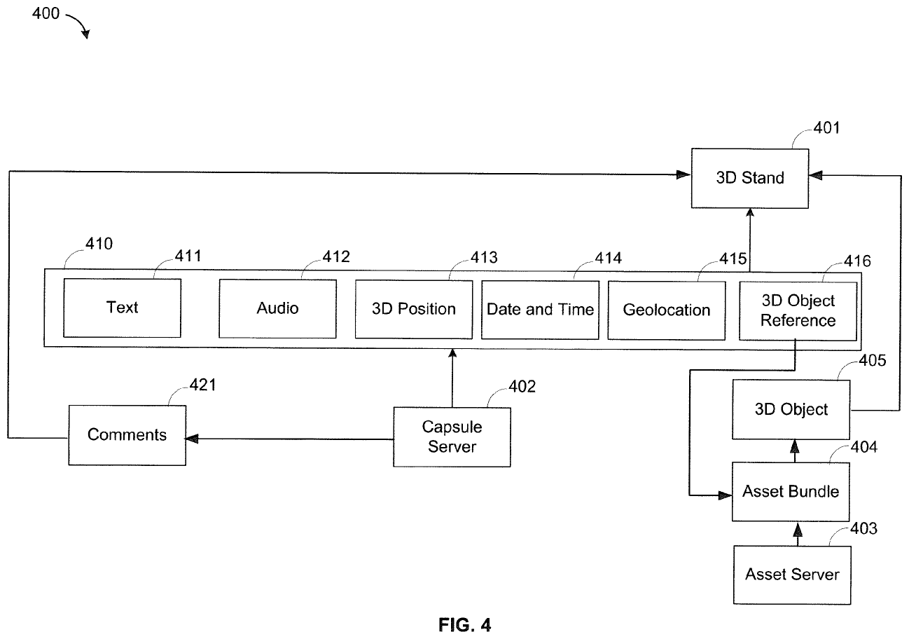

Referring now to FIG. 4, shown therein is an example embodiment of a system 400 for displaying 3D content in a VR environment. The system 400 can be managed by the system server 102 in FIG. 1B.

The system 400 provides a 3D stand 401 (which may also be referred to as a 3D slot) and indicates the location within the 3D space in which the associated 3D content can be placed. The 3D stand 401 includes various 3D content 410. The 3D content 410 includes one or more of a 3D object reference 411, text 412, audio 413, 3D coordinates 414, a date/time 415, and a (real world) geolocation 416. The 3D stand 401 can be shown on the display 106 of the system server 102.

The 3D content 410 can be stored on and provided by a capsule server 402, which may be the capsule server 144 of the system server 102. The 3D stand 401 can have associated comments 421. The comments 421 (e.g., created by the user device 101 operated by a visitor) can change if the 3D content 410 changes. The comments 421 can also be specific to one or more of the 3D object reference 411, text 412, audio 413, 3D coordinates 414, date/time 415, and geolocation 416. The comments 421 can be stored on the capsule server 402.

The 3D object reference 411 is used to retrieve a 3D object 405 from an asset bundle 404. The 3D object reference 411 may refer to an object such as a sailboat, hat, anchor, special flower, sword, or sewing kit. There can be a huge collection of 3D objects so that users can choose the ones that relate to the story being told. The asset bundle 404 is retrieved from an asset bundle server 403. The asset bundle server 403 may be the asset bundle server 143 of the system server 102.

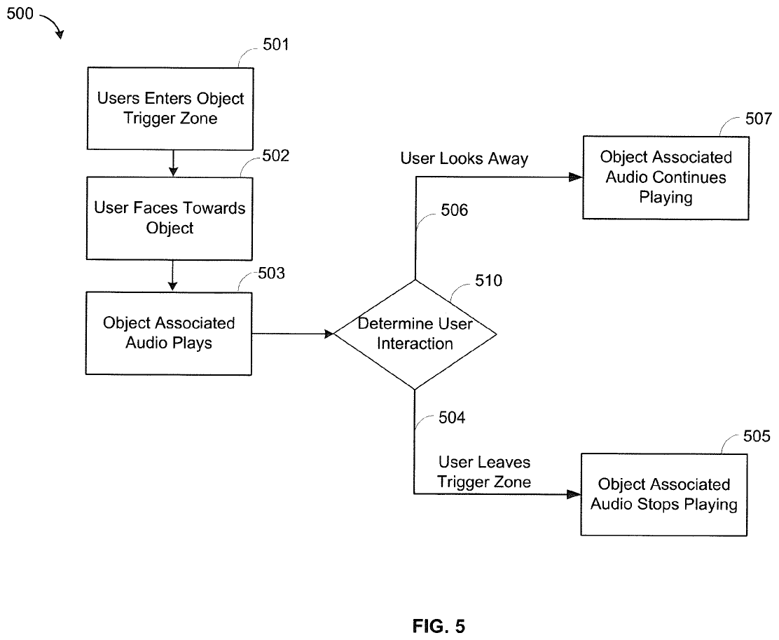

Referring now to FIG. 5, shown therein is an example embodiment of a method 500 of triggering the output of audio in the VR environment. The method 500 can be performed by the system server 102 in FIG. 1B. Some or all of the acts (or blocks) of method 200 may be performed by the processor unit 104.

At act 501, the system server 102 receives data from a user device 101 corresponding to a user entering the trigger zone of an object. The trigger zone can be represented as a cube (or other geometric object) within VR environment (by the software used to render the 3D environment such as Unity) and the trigger zone is used to detect when a user's simulated position is inside of it. Whenever a user passes through the cube, an action is triggered. Once the user enters the trigger zone, the system server 102 tracks the direction that the user is facing.

At act 502, the system server 102 receives data from the user device 101 corresponding to a user facing an object. If background audio is playing, then it fades away.

At act 503, the system server 102 plays audio associated with the object. The object-associated audio can fade in, for example, as the background audio fades away.

At act 510, the system server 102 receives data from the user device 101 corresponding to a change in the user orientation or location. The user may look away, which is decision branch 506. The user may leave the object trigger zone, which is decision branch 504.

If branch 504 is followed, the system server 102 continues to act 505, causing the object-associated audio to stop playing. Branch 504 can be followed regardless of whether the user is facing the object or not. The background audio can be output again and be faded in.

If branch 506 is followed, the system server 102 continues to act 507, causing the object-associated audio to continue playing. Branch 506 is followed as long as the user does not leave the object trigger zone.

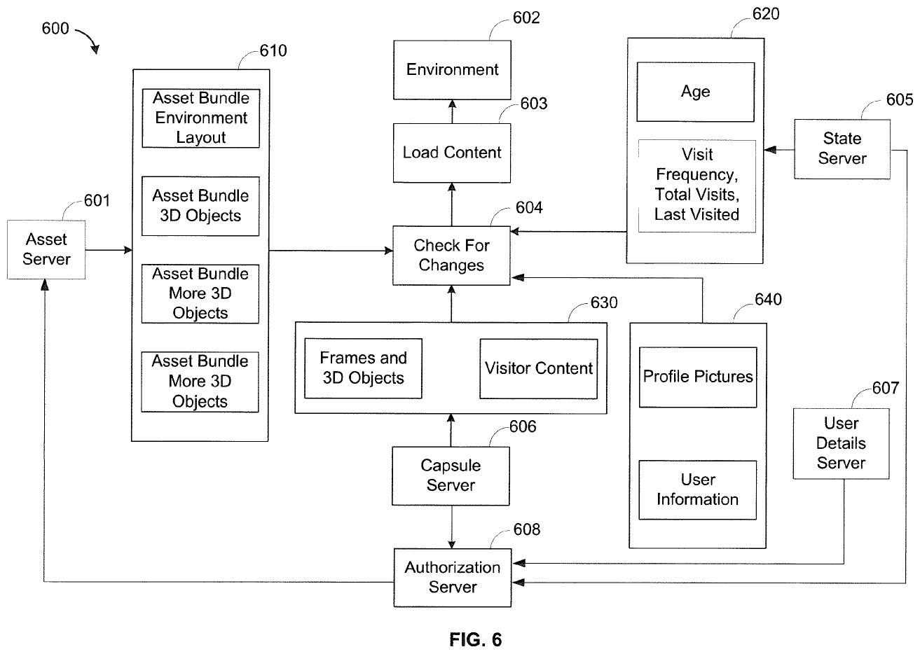

Referring now to FIG. 6, shown therein is an example embodiment of data flow 600 during construction of a dynamic VR environment. The data flow 600 can be managed by the system server 102 in FIG. 1B. Some or all of the data flow 600 may be initiated or performed by the processor unit 104.

The data flow 600 describes how the VR environment is constructed when, for example, a user device 101 accesses the system server 102 to create, modify, or view the VR environment. The data flow 600 includes data flowing to and/or from an asset server 601, a capsule server 606, a state server 605, an authorization server 608, and a user details server 607, which can be the asset bundle server 143, the capsule server 144, the environment state server 145, the authentication server 146, and the user details server 147, respectively, of the system server 102.

At act 604, the system server 102 checks for changes from one or more servers, such as the asset server 601, capsule server 606, and state server 605. Whenever a change is made to any data stored on the server for the specific simulated environment, a “Last Changed” date is updated on the server. If a local “Last Changed” date differs from the servers date, then the local system retrieves the changes from the server. If all servers report no changes since the last launch of the VR environment, the VR environment starts up with previously downloaded content. If any of the servers report changes since the last launch of the VR environment, then the system server 102 downloads updated content.

At act 603, the system server 102 loads content into the VR environment, which may be varied depending on any changes reported at act 604. For example, the location, text and/or images for certain objects in the content may be updated since the last time the VR environment was operated as this content may have been added by other users. Alternatively, the objects themselves may have changed in appearance due to passage of time as is described herein (i.e. trees growing, buildings looking older, etc.).

At act 602, the system server 102 causes the VR environment to be displayed. The system server 102 may display a VR environment on the display 106, which can be a VR headset. Alternatively, or in addition, the system server 102 may communicate the VR environment to a user device 101, which can be a VR headset. The VR environment may be displayed in whatever format bests suits the display 106 or user device 101 that shows the VR environment. For example, when the display 106 or user device 101 is a VR headset, the format may be a 3D stereoscopic image resulting from the angling of two 2D images generated by internal LCD displays. As another example, when the display 106 is a computer monitor, the image format may be a 3D rendering that is suitable for display on a 2D monitor. As another example, when the device 101 is a gaming console, the format may be the image format native to the gaming console, such as 3D for a Nintendo Virtual Boy or 2D (with 3D controllers) for a Nintendo Wii.

The asset server 601 provides asset bundle data 610, which includes an environment layout, which is used to generate the building and surrounding environment. The asset bundle data 610 also includes 3D object asset bundles, all of which can be used to separate out 3D downloadable content (e.g., flowers) that can be placed at a scene (e.g., a memorial), and 3D objects placed on the 3D stands. The asset bundles and 3D stands can be associated together as described in FIG. 4.

The capsule server 606 provides capsule data 630, which includes the frames and 3D objects associated to the VR environment, as well as the visitor content placed by users through their user devices 101 while visiting the VR environment.

The state server 605 provides the information on the state of the VR environment 620, including when it was created (or its age), total visitors, visitor frequency, when was the museum last visited, by whom, and other related information. The state server 605 can also provide information on which users are allowed to access this specific VR environment. This access information can be set by the owner or administrator of the VR environment.

The user details server 607 provides information on the users of the VR environment 640, which includes the profile pictures and other relevant information for visitor content. The visitor content and user information can be matched by a user ID, where matching means that there is an association between the user content and the user ID. For example, the User Content may contain an “Owner ID” which points to a user which can be compared with the user ID of other submitted content to see if there is a match.

The authentication server 608 connects to all other servers that the user accesses through the user device 101, allowing the user device 101 to access a particular user's content and verifying that the user in question is allowed to access personal content (or group content when shared access is limited to specific users).

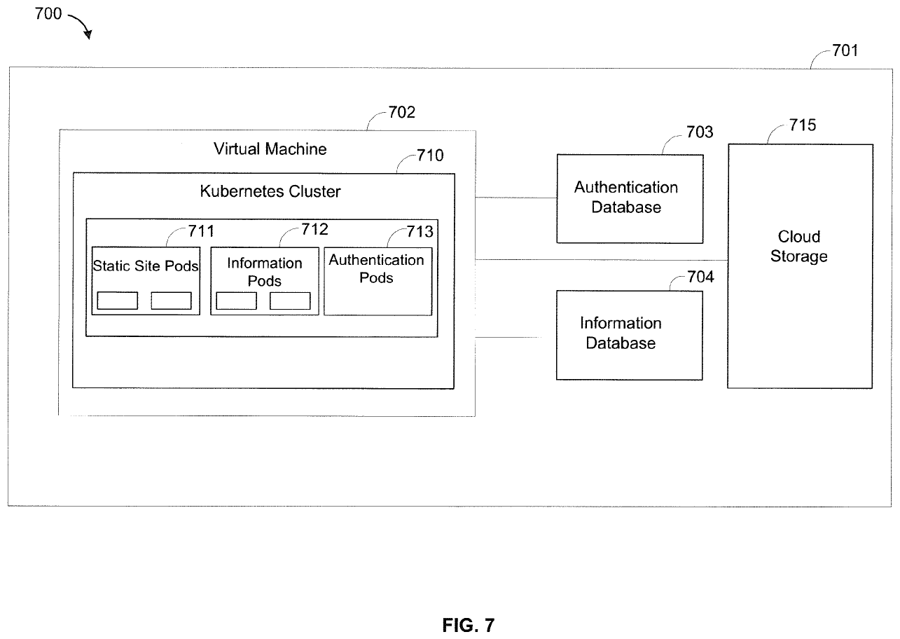

Referring now to FIG. 7, shown therein is an example embodiment of a system 700 for deployment of a dynamic VR environment. The system 700 can be managed by the system server 102 in FIG. 1B.

The entire system 700 may be set up on the cloud 701. Alternatively, portions of the system 700 may be set up on the cloud 701 while other portions of the system 700 are locally distributed (e.g., to a viewing location where users can borrow special-purpose user devices 101, such as VR headsets).

In the cloud 701, there is a virtual machine 702 that contains a cluster 710 (e.g., a Kubernetes cluster). However, other types of clusters can be used.

Within the cluster 710, there are pods that run their respective types of servers. The pods include static state pods 711, information pods 712, and authentication pods 713. The pods 711, 712 and 713 are used to run the server code, and can receive HTTP requests and provide responses. Accordingly, the authentication pods 713 are used to provide user authorization for users accessing and/or trying to modify a simulated environment. The information pods 712 are used to run software for updating the main state of the simulated environment, such as including new content that has been added and tracking/showing changes to the content over time. The static state pods 711 are used to maintain the current state of content of the virtual environment until they are next updated due to user interaction or a modification by the environment owner.

In the cloud 701, there are: an authentication database 703 that connects to the authentication pods 713; and an information database 704 that connects to the information pods 712. The authentication database 703 contains details on the users that are used by the authentication pod 713 when a particular user wants to access the virtual environment and is given certain privileges for modifying the environment. The authentication database 703 can be checked by the authentication pod to determine if the particular user has permission to access and/or edit the environment.

The virtual machine 702 may connect to cloud storage 715, which can be used for storing video, images, files, and other information or data. Alternatively, or in addition, the virtual machine 702 may connect to one or more private servers, for example, or other suitable remote storage.

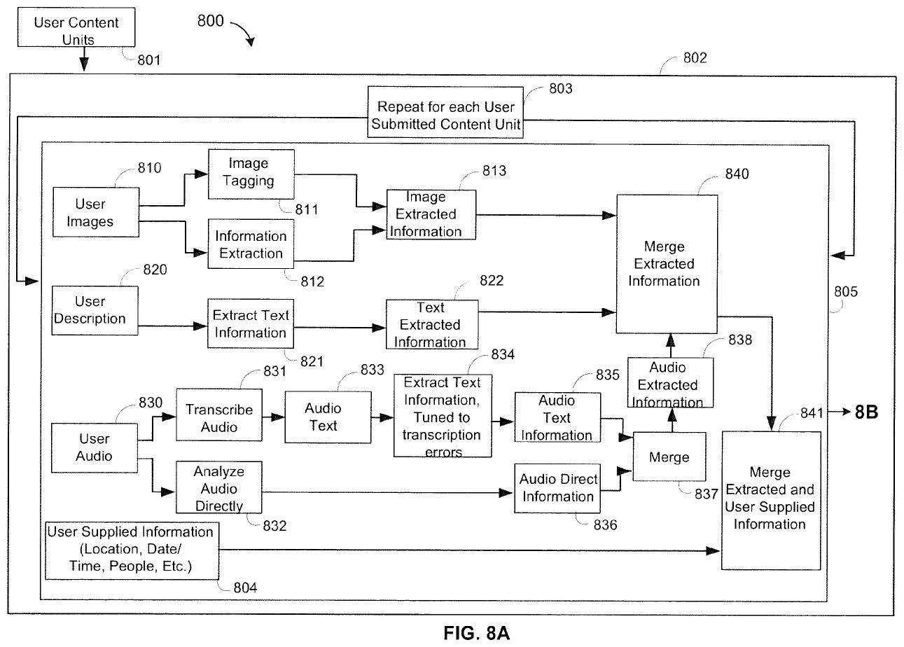

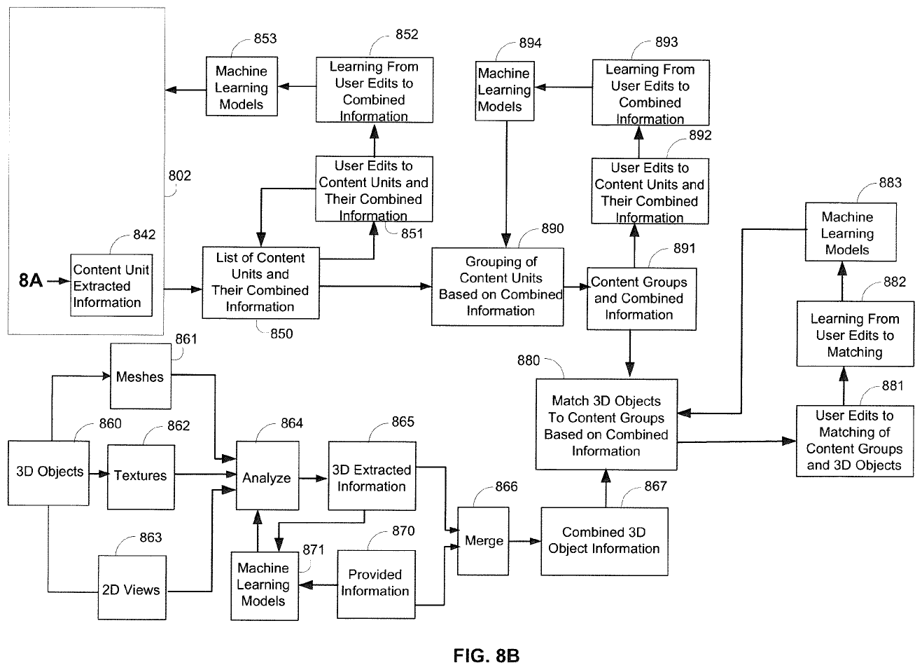

Referring now to FIGS. 8A and 8B, shown therein is an example embodiment of data flow and a method 800 for customization of a dynamic VR environment based on multimedia and social data. The data flow 800 can be managed by the system server 102 in FIG. 1B. Some or all of the data flow 800 may be initiated or performed by the processor unit 104. For readability only, the data flow 800 is shown in two figures, with FIG. 8A showing an arrow with “8B” to show the connection to FIG. 8B and with FIG. 8B showing an arrow with “8A” to show the connection from FIG. 8A.

A list of content units 801 that the user has uploaded is submitted into the main information extraction system 802.

The main parts of each content unit include one or more of images 810, a user description 820, and audio 830. The user device 101 also supplies information 804 such as content location, date/time, and people involved 804 (i.e., user identities for the users of the user device 101).

The images 810 are passed into image recognition programs, which tag the images at act 811 and extract the common information at act 812 (e.g., location, date/time). The image tags and common information are then combined at act 813 for consolidated image extracted information.

The user description 820 is text that the user inputs when creating the content item and the user description 820 is passed to natural language processing (NLP) programs to extract common information at act 821. The common information includes Tags, Date/Time of the content (e.g. a date a photo was taken when the content is a photo), and content location that are common for content items that are processed by the algorithm and is then grouped together. For example, image tags extracted from Images can be combined with text tags extracted from text for common content items. The result is the text extracted information 822.

The audio 830 is analyzed in two separate ways. The audio itself is directly analyzed at act 832, using semantic analysis on the pitch of the user's voice and other audio techniques. The audio is also transcribed at act 831 into text and the audio text 833 is passed to the natural language processing tools which extract text information at act 834. These NLP tools are different from those used for the user description because these NLP tools (i.e. which may be machine learning algorithms) are tuned to flaws in the audio transcription process. For example, the tuning may be by training the NLP algorithms on text that comes from an automated transcription of speech to text, rather than on text that has been directly written by a user; this training makes the MLP algorithms better at picking up information and accounting for errors in automated speech to text conversion. The common information extracted from the audio text information 835 and audio direct information 836 from the audio analysis is then merged together at act 837 to provide the resultant audio extracted information 838.

The common information extracted from the multimedia (image, text, and/or audio) is merged together at act 840. Differences in information extracted (e.g., the location shown in an image is Paris, while the location from the description is London) will prioritize specific types of content (image vs. text vs. audio) based on adjustable weights assigned to each multimedia, and the weights can be combined if multiple media have the same extracted information (e.g., description and audio say London, but image is perceived to be Paris).

As an example, suppose an image weight is I=2, an audio weight is A=5, and a description weight is D=4. If the image and description say that the content it is Paris, then the combined weight in favor of Paris is 6, whereas the audio is in favor of London, which only has a weight of 5 on its own.

At act 841, the extracted information is then merged with the information provided by the user (e.g. when the user provided information for the content they uploaded). The user provided information is prioritized over the extracted information. The user can provide the same set of information as that being extracted, such as content location, date/time associated with what is in the content, persons, tags, and categories.

The extraction is repeated by a loop 803 for each content unit in the list of content units that were submitted.

At act 850, the information extraction system 802 outputs the content unit extracted information 842 into the list of content units and the combined information of all of the content units. The merged information is the “combined extracted information”, which combines the different sources to get the information such as location, date/time, persons, etc.

The user can make additional edits at act 851 to the combined extracted information of each content unit. The edits are compared to the combined extracted information at act 852 by computing a loss function based on the differences between the predicted grouping and the grouping after user edits. This loss function is then used to adjust the weights and/or structure of machine learning models at act 853 that can be used for extracting the combined information to improve the future expected value of the loss function. For example, these machine learning models may be those used for image recognition and natural language processing (for example at 811, 812, 834 and/or 832). The updates to the machine learning models are fed back to the information extraction system 802 to improve the operation of the various extraction processes.

The content units 850 are then grouped at act 890 into content groups 891. The grouping is done by matching the combined information of multiple content units so that similar content units are placed in the same content group. The matching can be done by determining a correlation score for how similar the tags associated to the content units are, and another correlation score for how similar the extracted information for the content units are). In a particular implementation, weights are assigned to the importance of each data point of the content units (such as content location, a date for what is in the content (i.e. the date when a photo was taken), a tag such as “cars”) and if those match between content units, the “match score” is increased; the system tries to maximize the match score. The user can then make edits to the content groups 850 at act 892. At act 893, the user edits to the content groups are then used at act 894 to improve the machine learning models used for grouping; the methods used for updating the machine learning models can be similar to the how the machine learning models were updated (e.g. “learned”) from user edits to the extracted information of content units.

The next step is to process the 3D objects. For example, one or more 3D objects 860 are taken from a source (e.g., a library of 3D objects) and are analyzed (e.g., using pattern matching) to match with the content groups.

The meshes 861, textures 862 (which include, but are not limited to, color textures, normal maps, bump maps, etc.), and 2D views 863 of the 3D object (which can be a rendering of the object taken to form a 2D image) are all analyzed at act 864.

The analysis at act 864 extracts the same information as the other information extractors in previous blocks (such as block 812), which includes tags, location, and date/time. The analysis at act 864 produces 3D extracted information 865.

The 3D extracted information 865 is merged at act 866 with the provided information 870 for the 3D object to produce combined 3D object information 867. The provided information 870 can be information provided by a user for a content object and this information can include tags, date, and location for a content object. The 3D objects may be modeled by 3D artists or purchased. The 3D extracted information 865 and the provided information 870 are used to train and improve the machine learning models at act 871, and the improved machine learning models are then used for future analysis at act 864. The machine learning methods that are used can be similar to the machine learning methods that were used to update the machine learning models based on user edits to the extracted information of content units.

The combined 3D object information 867 is then used for object matching at act 880, where the combined information on content groups 891 is used to match content groups with 3D objects. Once content groups are created, they have tags, locations, and times for the content objects in the content group. The 3D objects have the same information associated with them. Accordingly, correlations between tags, proximity of location and time can be used to assign 3D objects that are most similar to the content group.

The user can then make edits to the matches at act 881, and at act 822 the system learns from the user edits to improve the machine learning models at act 883. The improved machine learning models are then used in future iterations of the 3D object matching performed at act 880. The machine learning methods that are used can be similar to the machine learning methods that were used to update machine learning models based on the user edits to the extracted information of content units.

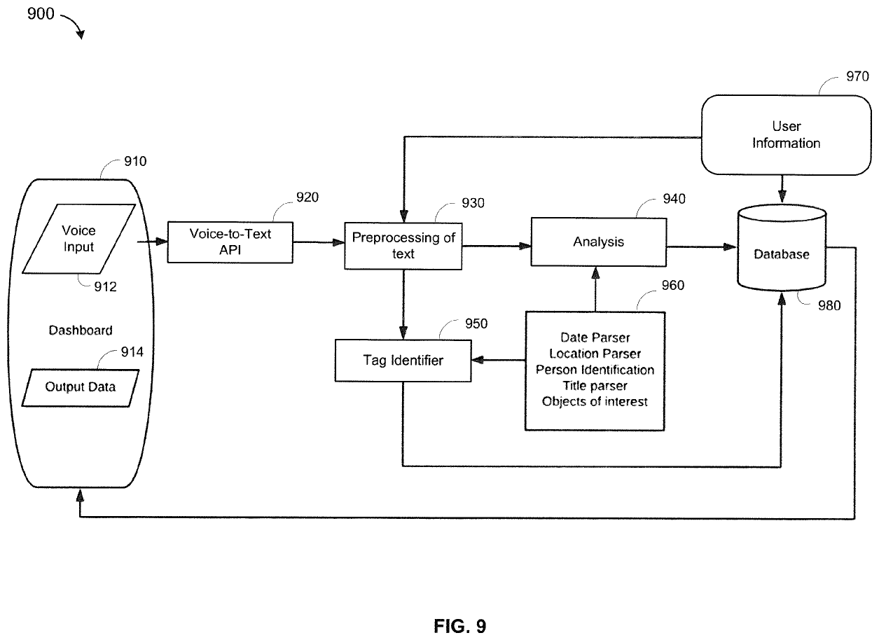

Referring now to FIG. 9, shown therein is an example embodiment of method 900 including data flow during voice transcription of a dynamic VR environment. The method 900 and associated data flow can be managed by the system server 102 in FIG. 1B. Some or all of the method 900 may be initiated or performed by the processor unit 104.

The method 900 is controlled by a dashboard 910 that is provided by the system server 102. The dashboard 910 is a user interface that is operable to receive voice input 912 from a user device 101. The dashboard 910 can display output data 914 to the user device 101.

At 920, a voice-to-text API is used to process the voice input 912 (received from the user device 101) into text and output the text for further preprocessing of the text at act 930. The preprocessing of the text at act 930 utilizes user information 970 for context so that the text is more relevant to the user of the user device 101 from which the system server 102 receives user-specific data. For example, if it is known that the person for a whom a virtual environment is about lives in England, then most of the stories for this person will be about England, so if the person mentions going down to the pub in a voice file, then with a higher degree of accuracy it can be predicted that the pub is located within England rather than somewhere else. Other background data about the person may be used similarly.

The output from the preprocessing of text at act 930 is sent for further analysis at act 940, as well as for tagging by a tag identifier at act 950. The further analysis at act 940 refers to the actual extraction of meaningful data such as extracting date, time, place, and tags, for example, while the previous act may be used to “clean up” the text. At act 960, a parser parses from the transcribed text for determining at least one of date/time, location, person identification, titles, and objects of interest which are then used by the analysis performed at act 940 and the tag identification at act 950.

Output from the analysis at act 940 is sent to a database 980, which can be the database 130 of the system server 102. Output from the tag identification at act 905 is sent to the database 980. User information 970 can be stored in the database 980. Data and results stored in the database 980 can be sent to the dashboard 910 for display in whole or in part as output data 914. The user can check and edit the results shown in the output data 914. In at least one implementation, edits to the results are stored as well and used to retrain the machine learning algorithms, such as those used for analysis in extracting information about the content items like date, time, location, tags and the like.

In at least one embodiment, the method 900 for performing voice transcription is enabled by artificial intelligence (AI), such as machine learning. The system server 102 can use AI to create a personalized story-telling experience for the user devices 101. The AI “understands” each user and customizes the flow of the narrative to best capture an accurate depiction of the past (whether it be a specific memory or story). The voice transcription serves as an assistant that not only understands the story as it is told but utilizes decades of empirical findings, grounded in memory theory, to personalize the experience. This facilitates accurate and precise generation of a person's voice (i.e. for the person for whom the memorial is for) and simulates new recordings of that person for whom the memorial is for.

In at least one embodiment, the method 900 for performing voice transcription uses AI to learn the voice of a user associated with a user device 101. For example, the voice of the user can be learned by using third-party libraries such as Lyre bird or Microsoft's custom voice fonts. The content to be said can start off with preset sentences such as “I was born in [city], when to school in [school], and graduated with a degree in [degree]”, which can be said in the voice of the intended person. Once enough data is acquired from users, machine learning models are trained to structure sentences and respond in a way that is more unique to a specific user.

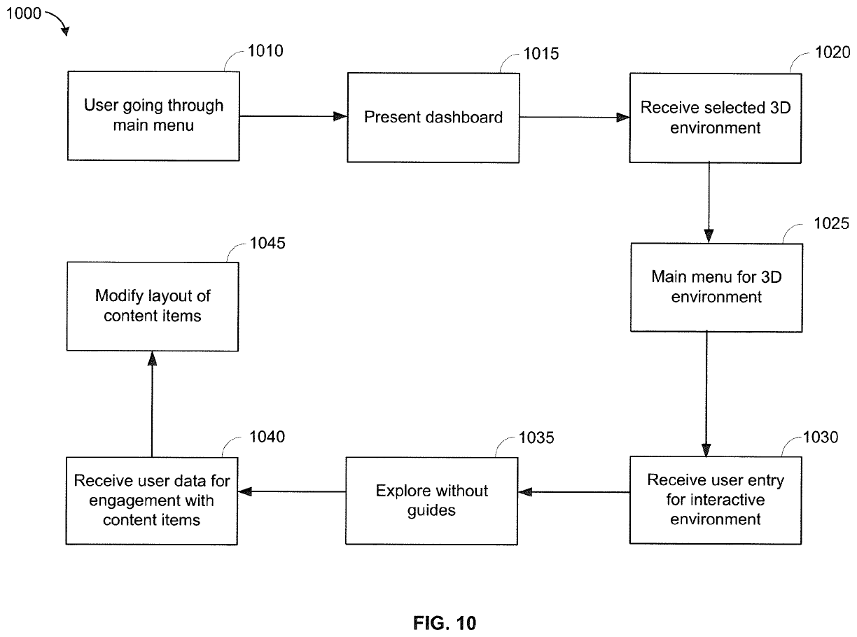

Referring now to FIG. 10, shown therein is an example embodiment of a method 1000 of displaying and interacting with multimedia content in a 3D environment. The method 1000 can be performed by the system server 102 in FIG. 1B. Some or all of the acts (or blocks) of method 1000 may be performed by the processor unit 104.

At act 1010, the system server 102 receives data from a user device 101 corresponding to a user going through a main menu screen. At act 1015, the system server 102 presents the user device 101 with a dashboard of the 3D environments that the user device 101 has access to. The system server 102 displays detailed information and data about the activity of the 3D environments. The activity includes, for example, users visiting the 3D environment, interactions with the 3D environment, and special events.

At act 1020, the system server 102 receives data from the user device 101 corresponding to a selection of a specific 3D environment. At act 1025, the system server 102 directs the user device 101 to the main menu of that 3D environment and provides the user device 101 with the choices to enter an interactive mode, view a video, and adjust settings for both visual data and audio.

At act 1030, the system server 102 receives data from the user device 101 corresponding to user entry of the interactive environment (i.e. simulated environment). At act 1035, the system server 102 provides the user device 101 with the freedom to explore the interactive environment. The user is free to move within the VR environment and interact with all interactable objects; a guide may or may not be present. Each section of the VR environment can have many content items on display. The content items can be grouped into content groups, which make up the VR environment. The content groups can represent one or more content items such as, but not limited to, photos, videos, models, and/or 360 degree videos, which can have secondary interactions with audio, language, and/or animation.

At act 1040, the system server 102 receives data from the user device 101 corresponding to engagement with the content items. At act 1045, the system server 102 modifies the layout of the content items, adapting to user engagement over time where the user engagement is communicated from the user device 101. For example, if a user of the user device 101 provides interaction data that indicates a preference or gravitation towards particular content items, such as by entering a trigger zone, additional interactions become possible. For example, the system server 102 may provide a suggestion for the user device 101 to contribute comments related to the content item or in the guestbook. Advantageously, in at least one embodiment, the system server 102 provides custom animations triggered by a set of user interactions, whether those animations be with a 3D model, a popular picture frame or some other object in the 3D environment.

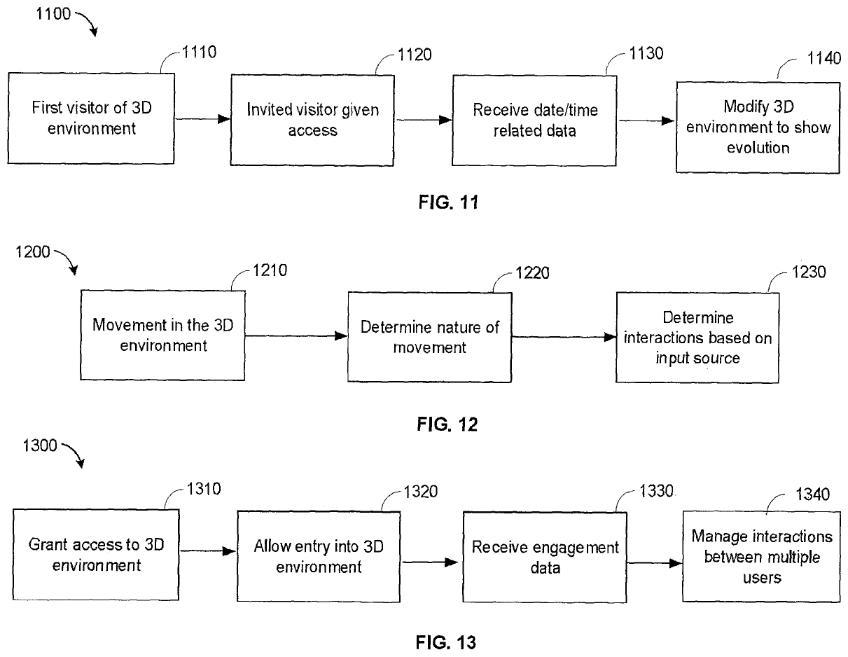

Referring now to FIG. 11, shown therein is an example embodiment of a method 1100 of changing certain objects in a 3D simulated environment. The method 1100 can be performed by the system server 102 in FIG. 1B. Some or all of the acts (or blocks) of method 1100 may be performed by the processor unit 104.

At act 1110, the system server 102 receives data from a user device 101 corresponding to a first visitor of the 3D environment. The first visitor can be the creator and thus starts the evolution from the second they begin engaging with virtual content of the VR 3D environment. The owner's interactions are weighted uniquely to contribute to the changing environment.

At act 1120, the system server 102 receives data from the user device 101 corresponding to an invited visitor who is given access to the 3D environment. The actions of the user via the user device 101 can trigger changes to content items on the interior and exterior of the 3D VR environment. For example, the user through the user device 101 may trigger animations and audio which captures direct connections between the content item and associated user behavior. Also, for the exterior of the 3D VR environment, there can be changes in the texture and the 3D model.

At act 1130, the system server 102 receives data/time related data (or other 3D environment related data) to cause the 3D environment to naturally evolve from one time to another, such as from day to night, night to day, week to week, or season to season. The other 3D environment related data can include, for example, passage of special events (e.g., Christmas, Halloween) and also major world occurrences such as an earthquake or a volcano erupting.

At act 1140, the system server 102 modifies the 3D environment to show time-related evolution. For example, a virtual plant object may grow, a virtual building may collect dust, and the outdoor objects of the simulated environment may flourish. Evolution can be based on time and on user interactions, as well as on real world events. For example, many user devices 101 interacting with the 3D environment at the same time on a special day, such as for a funeral, may unlock new interactions in the environment. Examples of these new interactions include, but are not limited to, allow the user access to new areas, allowing the user to leave messages in restricted areas, and allowing the user to play various games.

Some major events, such as natural disasters, or geopolitical events may be reflected within the simulated environment as well. For example, if there is a historical war, this will have an impact on the look of the simulated environment. Information on this impact can be collected by analyzing the existing content units, and from news on the Internet or other data source.

Referring now to FIG. 12, shown therein is an example embodiment of a method 1200 of managing navigation in a 3D simulated environment. The method 1200 can be performed by the system server 102 in FIG. 1B. Some or all of the acts (or blocks) of method 1200 may be performed by the processor unit 104.

At act 1210, the system server 102 receives data from a user device 101 corresponding to the user's desired movement in the 3D environment. Similar to many 3D environments, a user can walk, speed walk, jump, and crouch. This can create an in-game experience that allows the user to adapt to any view perspective or string of movements that they want to execute.

At act 1220, the system server 102 determines the nature of the movement in the 3D environment, identifying any special tasks, such a selecting objects or triggering interactabilities with certain hotkeys on the keyboard or onscreen. These hotkeys may initiate changes to at least one of content items, animations with 3D models, changes to the natural VR environment, and guestbook interactions.

At act 1230, the system server 102 determines interactions based on where the input comes from. A user device 101 can operate as a first person operator within the 3D VR environment but can take different forms depending on the evolution of the VR environment over time. For example, a visitor gifts the 3D simulated environment a virtual pet. The user device 101 can then assume the perspective of the virtual pet, whether it be a dog, bear, or bird. The system server 102 can then update the 3D simulated environment with VR interactions, such as the user picking up objects with their hand(s), the user inspecting the object closely, and head tracking of the user's simulated representation in the 3D simulated environment.

Referring now to FIG. 13, shown therein is an example embodiment of a method 1300 of managing collaboration in a 3D environment. The method 1300 can be performed by the system server 102 in FIG. 1B. Some or all of the acts (or blocks) of method 1300 may be performed by the processor unit 104. In a particular implementation, managing collaboration means giving users, via their user devices 101, access to visit the environment, access to comment on objects, and separate access to be an administrator, which allows them to make more modifications to certain aspects/objects of the simulated environment.

At act 1310, the system server 102 provides data to a user device 101 corresponding to granting or denying the user device 101 access to the VR environment by a creator of the 3D environment. The creator is the primary access owner and is the only person that can grant access to other users after the VR environment is auto-generated. The access to external users may be granted via a unique URL-based (Uniform Resource Locator based) invitation code.

At act 1320, when access is granted, the system server 102 allows a simulated representation of an external user to enter the 3D environment and interact with full operational capabilities via their user device 101.

At act 1330, the system server 102 allows the external user, via their user device 101, to begin interacting with the 3D VR environment and engage with various content items. The system server 102 receives data from the user device 101 relating to the engagement of the user with the various content items. This engagement includes, for example, triggering audio at content items and animations associated to interior and exterior content items; for example the interior content items can be in a building and the exterior content items can be outside of the building. The user, via their user device 101, can collaborate by leaving multimedia posts within the guest book of a memorial 3D environment or by model-based gifting such as skipping a coin, placing a flower, or gifting a pet to the 3D environment.

At act 1340, the system server 102 polls multiple user devices 101 accessing the 3D VR environment to support a multi-user experience. The system server 102 can act as a communications hub to allow the various user devices 101 to interact together in real time through collective behaviors and individual behaviors. The combinations of collective behaviors of user engagement create their own unique set of interactions and animations. For example, a group of three users who, via their user devices 101, all send messages to pay respect to a virtual tree memorial can unlock a set of doves that will live in the tree and bring natural familiarity to the digital entity that is the virtual tree.

In at least one embodiment, the user, via their user devices 101, specify the type of their relationship (e.g., friend, spouse, brother, sister, grandparent) to an entity associated with the VR environment such as the creator of the VR environment or a person whose memorial is in the VR environment. The type of the relationship can then be used by the system server to control the reaction of the VR environment to user actions, as well as the types of actions available to these users via their user devices 101.

In at least one embodiment, a user device 101 designated as the owner can be used by the simulated environment owner to delegate secondary administrators (or “admins”), that have control over the museum, and also designate an inheritor, to whom the owner role will transfer if the original owner dies.

In at least one embodiment, user devices 101 operated by a future owner and/or administrator can be used by users to move content and add their own content in the VR environment, but they can never delete the virtual content from the VR environment that belonged to someone else, such as the original owner.

Referring now to FIG. 14, shown therein is a screenshot of an example of a first building exterior view from a VR environment. The screenshot shows the building exterior, the natural environment, and a garden. The buildings and environment will visibly age. For example, if users do not visit the building in the VR environment, it will gather dust, parts will rust, and have other aging effects. Once users come and visit the building in the VR environment, they can use various actions that are made available to them to breathe life back into the VR environment.

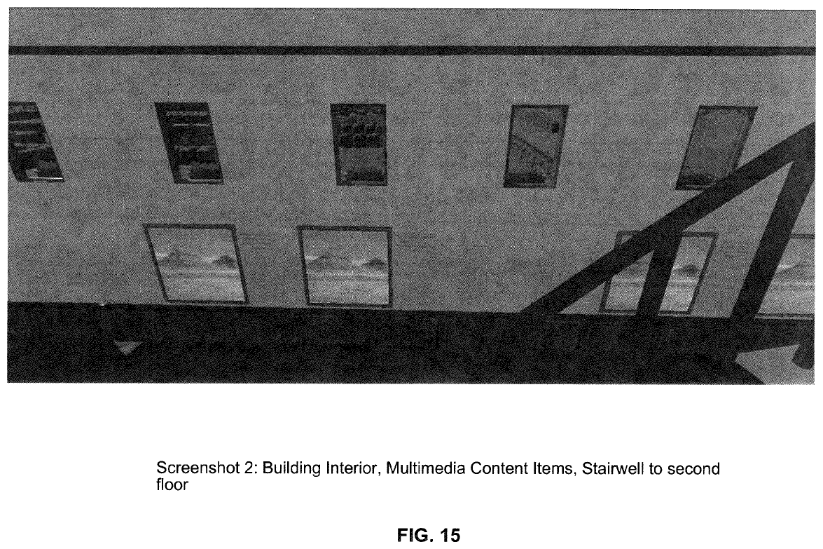

Referring now to FIG. 15, shown therein is a screenshot of an example of a building interior view from a VR environment. The screenshot shows the building interior, multimedia content items, and a stairwell to the second floor. The multimedia frames each contain one content unit, which can contain images, descriptions, videos, and audio. When the virtual representation of the user comes near a frame and looks towards it, audio may play. Also, users can leave comments on each content unit, further adding to the story. In at least one embodiment, the content units may also be dynamically moved around by how much users interact with them, and also can be moved by the VR environment owner. There is also an archive room where seldom used content can be moved without deleting it.

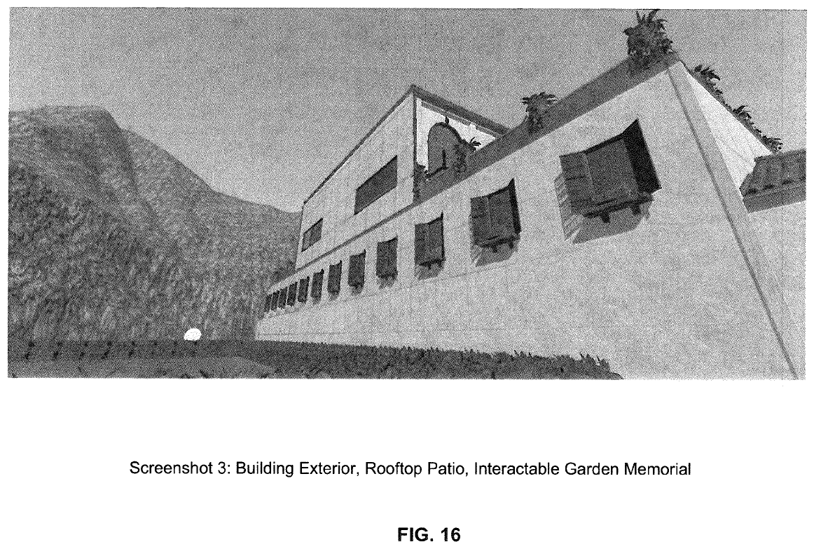

Referring now to FIG. 16, shown therein is a screenshot of an example of a second building exterior view from a VR environment. The screenshot shows the building exterior, a rooftop patio, and an interactable garden memorial.

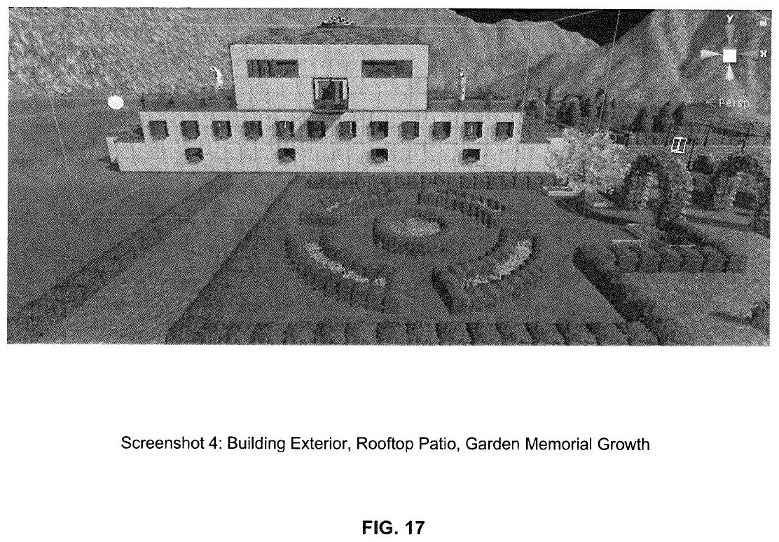

Referring now to FIG. 17, shown therein is a screenshot of an example of a third building exterior view from a VR environment. The screenshot shows the building exterior, a rooftop patio, and an interactable garden memorial. The garden memorial shows growth, which can be a result of such user interactions as recent visits or gardening by the owner and/or visitors.

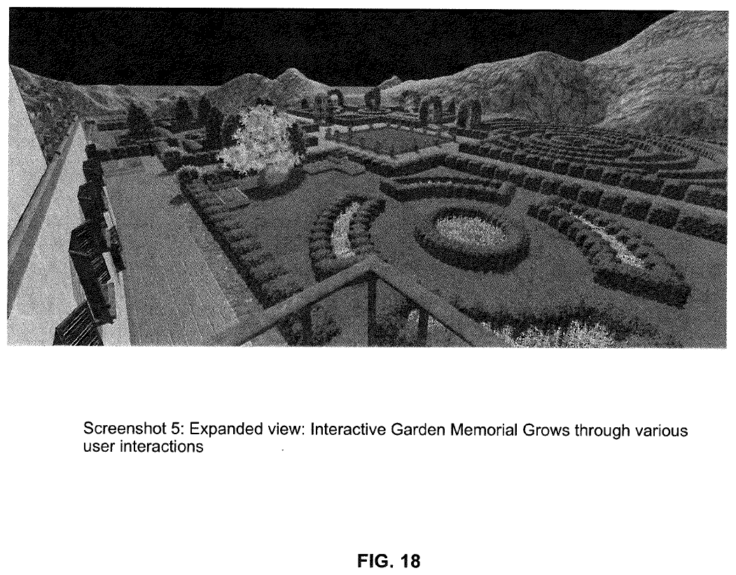

Referring now to FIG. 18, shown therein is a screenshot of an example of an interactive garden memorial view in a VR environment. The screenshot shows an expanded view of the interactive garden memorial and its growth through various user interactions.

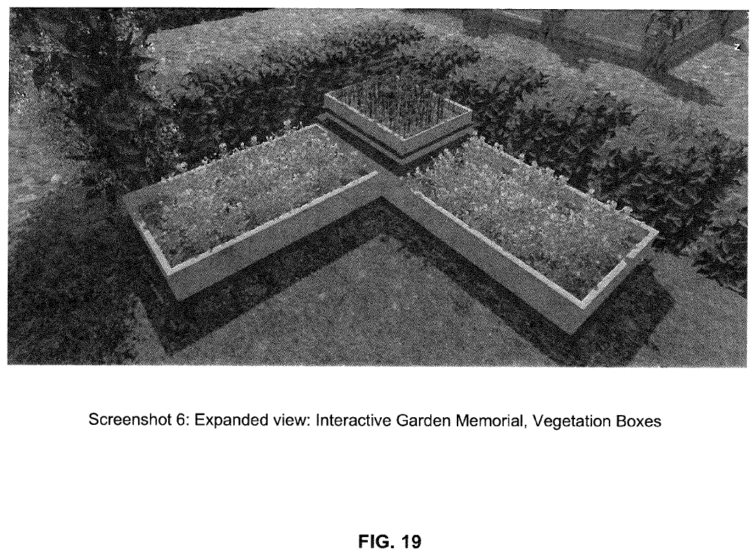

Referring now to FIG. 19, shown therein is a screenshot of an example of a second interactive garden memorial view in a VR environment. The screenshot shows an expanded view of the interactive garden memorial with vegetation boxes.

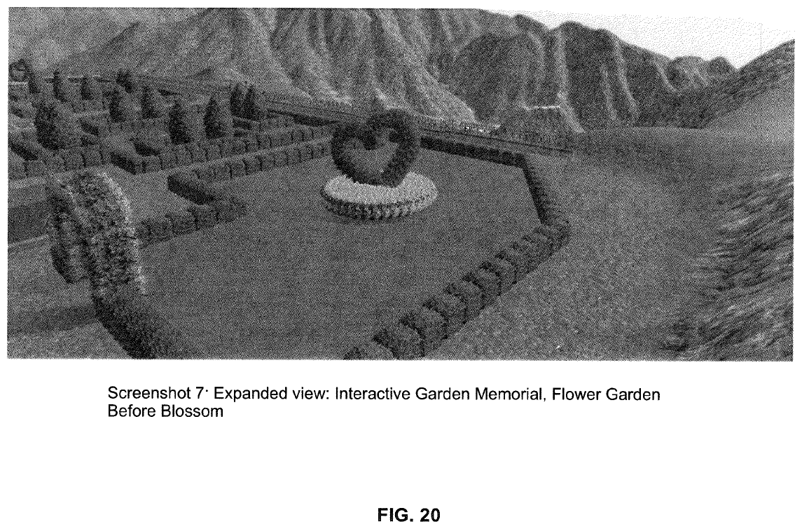

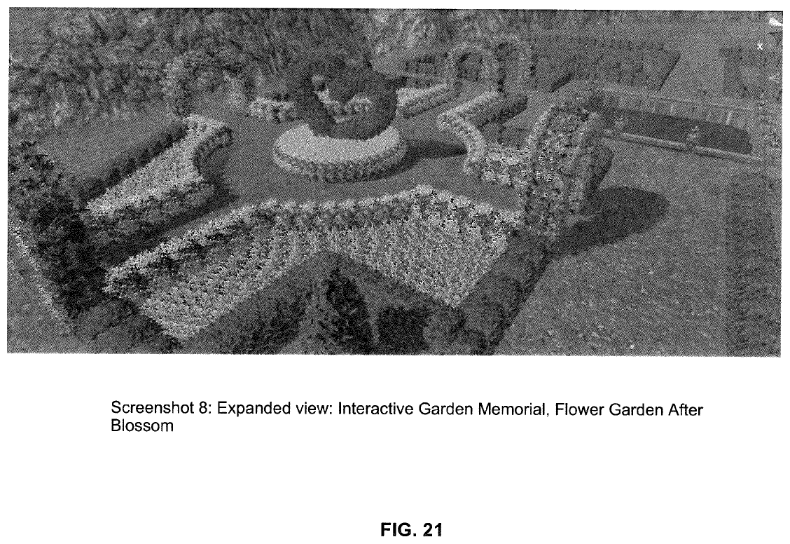

Referring now to FIGS. 20 and 21, shown therein are screenshots of an example of a third interactive garden memorial view in a VR environment. The screenshot shows an expanded view of the interactive garden memorial. FIG. 20 shows a flower garden before blossom, and FIG. 21 shows the flower garden after blossom. If users interact more with a particular section of the garden, that will result in a fast evolution path towards blossoming. Multiple users can also contribute to growth through certain activities within the VR Environment.

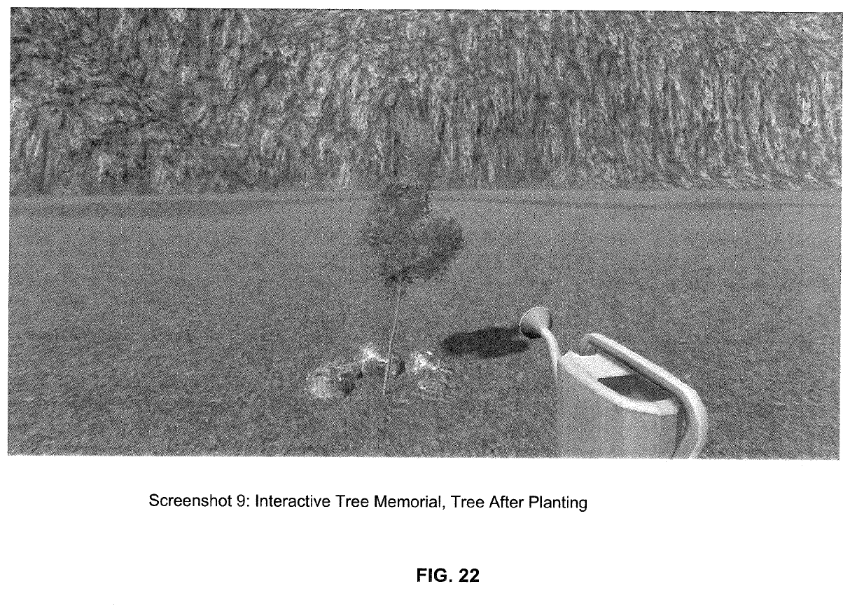

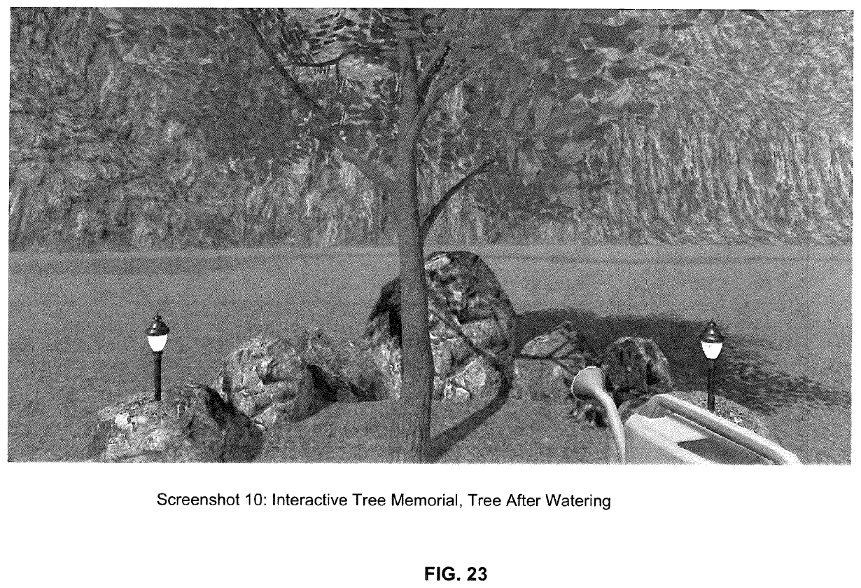

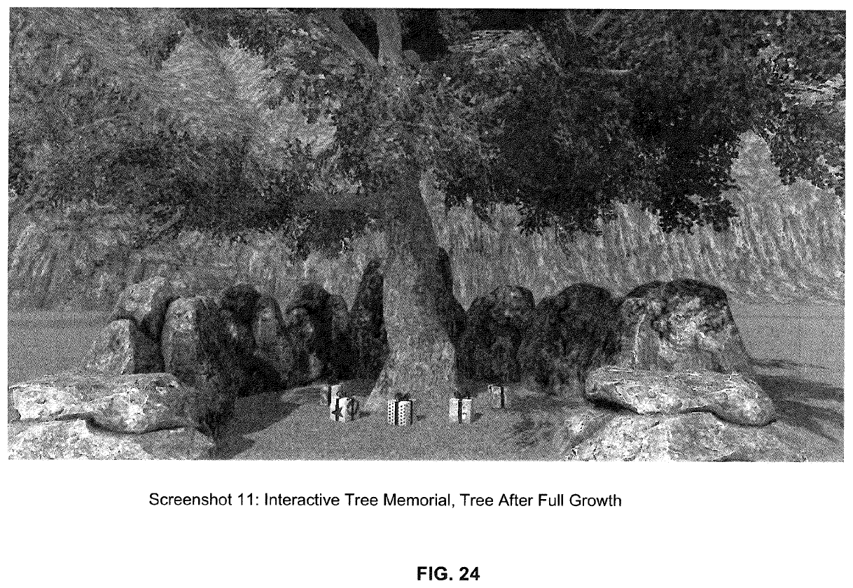

Referring now to FIGS. 22 to 24, shown therein are screenshots of an example of an interactive tree memorial view at various stages of growth in a VR environment. FIG. 22 shows the tree after being planting by a user. FIG. 23 shows the tree after being watered (e.g., on one occasion or multiple occasions). FIG. 24, shows the tree after full growth. Alternatively, or in addition, the evolution of the tree can be affected by other interactions or changes in the environment state, such as frequency of visitation, a change in seasons, or a triggering of a special event. For example, the appearance of gifts under the tree can be the result of a special event being triggered by multiple users visiting the tree at the same time.

Although the foregoing description is not limited to a particular VR environment, at least one of the various embodiments described herein can be implemented as a customized virtual memorial, virtual wedding, a virtual celebration, a virtual location, and the like, that is auto-generated from multimedia that is preserved for generations and evolves over time. As such, these embodiments provide a practical application of VR environments by, for example: customizing the VR environment as applied to a virtual memorial; auto-generating the customizations from multimedia files; and providing a system that allows evolution based on user-supplied content.

First, customizing the VR environment as applied to a virtual memorial can be at least in part accomplished by the 3D VR environment being synchronized with a web and mobile platform that may be used by different users. This combines into the overall platform, which maintains the simulated environment and enables users to interact together from various user devices and in varying levels of immersion. For example, a user can add a message from the web platform and gift an object, both of which are then integrated into the virtual environment for other users to see and interact with. The uniquely designed elements (building, guestbook, garden, memorial, 360 degree video park, exterior) of the 3D VR environment are synchronized together to create a unique technical solution for virtual memorialization. Each of these 3D modelled components communicate with each other to achieve a customized virtual environment as applied to a virtual memorial or another type of virtual event or virtual location. For example, a high level of activity in the virtual environment from visiting users will cause the memorial tree to grow; this will impact the overall vegetation of the environment to blossom, impacting the visual surrounding the exterior environment and 360 degree video pathway.

Second, auto-generating the customizations from multimedia files as applied to a virtual memorial can be at least in part accomplished by the automated tagging and organization of 3D objects, and then matching these 3D objects to organized multimedia content to improve the scalability of creating these environments and improving the user experience. The 3D tagging algorithm uses the 3D mesh of the object, the object textures, and 2D views of the object to accurately tag it. It then creates a mapping from 3D object tags to user-uploaded content based on tags on user images, location, descriptions, date/time, tagged users, and other user information.

Third, evolution of the VR environment based on user-supplied content as applied to a virtual memorial can be at least in part accomplished by the system auto-improving the virtual environment as the users interact with it and as time passes. The system keeps track of user interaction, improves the accuracy of tagging multimedia, including 3D content, and better organizes and archives the content based on this new information on how the accuracy of tagging can be improved. The system gathers data on user modifications to the structure, in order to learn/train a model that influences future content grouping and auto-generation of content.

Further, the tagging and 3D object selection system ensures that each virtual environment is relevant to the user, and impacts the types of interactions and evolution paths that are available to the user. The elements of the virtual environment layout combine and interact with the 3D objects that are selected based on user content and user activity guiding the evolution paths that are available. The synchronization of the different access points (e.g., game, desktop web, mobile) by the system add to the data available for tagging content and training the tagging algorithms (i.e. machine learning models) for improved accuracy over time.

Further, the automated tagging allows the system to be able to evolve over time. The changes are guided by understanding the details of the media (i.e. simulated objects) that users interact with. The evolution of the environment increases its uniqueness, which gives more reason than a regular environment or museum for the users to have repeat visits, learn new things as new content is added, and collaborate together with other users to add to development of the environment (e.g. developing the story of the person for whom the memorial is for).

In another aspect, the auto-generation server is a practical application for older adults to interact seamlessly through a user device of their choice to tell their story and record their memories. The auto-generation tools help older adults because they would not have to go through the tedious process of going through each area of the museum and uploading content themselves for each content item. Prior to auto-generation, a user has to complete a straightforward order form (provided by a user interface) in the web-based application to identify each section of a virtual memorial or other environment that they wish to update and associate/upload the related media and text copy that they want.

In at least one embodiment, a natural language processing tool can be connected to the order form user interface, allowing older adults to tell a story with voice via a microphone of their device and have that story transcribed and parsed into different categories (e.g., who, where, when, what, tags). This allows the older adult to build a skeleton of content that they can build on with input of other types of content via (i.e. image files, etc.) an input form or content creator form user interface. Voice applications for older adults can provide a more fluid means to controlling and receiving assistance from technology. Older adults and seniors can alternatively receive a guided experience from other users or access a pre-generated video flythrough of the virtual memorial.

In at least one embodiment, the VR environment can leverage multimedia or social data. The multimedia data or biographical information provided by the user during the content creation form can influence the decision tree for auto populating groups, 3D models, exterior styles, and building structures. In at least one embodiment, the analysis of multimedia can allow the system to make inferences that can prioritize the enhancements that are made to the environment. For example, if a user uploads a set of photos and descriptions that highlight WWII experiences, a machine learning model can be used to identify related groups of 3D models or gifting objects, and then associate them to content items within the environment. This association is based on processing the images through image tagging algorithms to extract information, processing the descriptions through natural language processing modules to extract further information, and then using all of the extracted information to match the content with 3D objects that have had the same key data points extracted from them (e.g., as described herein).

In at least one embodiment, the user interaction with the VR environment can be used for data analytics for customization of the VR environment, auto-generation of the simulated environment, or machine learning for improving the machine learning models that are used to customize the environment and/or modify the environment over time, which might be based on user submitted content and/or user interaction with content in the simulated environment. The data analytics can include data on user engagement that answer the following questions.
How many users the environment reached via email, SMS, external app sharing.
How many impressions were made by paid and unpaid users.
How many registered users visited the environment.
The number of registered users that engaged in the environment, guestbook, or virtual gifting.
How many registered users led to a new purchase from a non-registered user.
How much time was spent in the environment overall and per session.
The number of interactions with each content item, (which may be useful for archiving and sorting).
The data analytics can include at least one of: (a) user demographics, such as birth date, locations, and age of the user, (b) engagement score per user, (c) timing of engagement, (d) sentiment analysis, (e) content item engagement, (f) channel of engagement, and (g) paid transactions.

The data analytics can enhance customizability and optimization of the simulated environment in a number of ways. The data collected from the content creation form allows the system to make inferences about which sets of grouped 3D models to include in the respective simulated environment. The system can utilize data analysis of user engagement to influence the evolution pathway of each uniquely created simulated environment. Furthermore, the system can leverage insights to notify, target, and re-engage both creators and registered users who have been given access to a particular simulated environment.

In at least one embodiment, one or more of the servers, modules, or containers use machine learning as described herein. For example, deep neural networks can be used to tag and classify content in images, descriptions, and audio. The objects can be analyzed in similar ways and make use of Geometric Machine Learning. Random Forest (a form of decision trees) can also be used in at least one embodiment to implement one or more of the machine learning methods described herein. More generally, any user-submitted content can be analyzed to extract the combined set of data points mentioned before (e.g., location, date/time). Users can make edits to the extracted information, and to the groupings. User edits at any point in time can be stored, and the comparisons of the user edits to the previous version of the extracted information can also be stored, to better retrain the machine learning models.

In at least one embodiment, the system optimizes the placement of media within the virtual environment using different rules, which may be implemented by using variables. One variable is date/time, where the goal is to have the content tell a chronological story. The content is placed into groups by date/time, and then into subgroups by other variables. To be specific, the date/time is in reference to the time period that the content refers to, and not the upload time. For example, if today a user uploads a photo of their grandmother when she was young, the intended date/time is somewhere in the 1960's (e.g. when the grandmother was young), not the current date/time. The user may be encouraged to set the date themselves, but the system may also attempt to estimate the time period that the content comes from based on image recognition algorithms, the provided description, and other associated data. The subgroups can be defined by the other data points, such as location and personal relations. Each of these variables can have a pre-set weight on how much it affects the 3D positioning and selection of content. As more data is gathered from user adjustments, these weights can be modified, and even the current primary variable (e.g., time) may have its weight decreased to favor grouping content by content location, person, or another variable.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for auto-generating a simulated reality environment, the system comprising:
a data store; and
at least one processor coupled to the data store, the at least one processor being configured to execute:
an importing module that is adapted to receive multimedia content from at least one user device through a software application, and to store the multimedia content on the data store;
an auto-generation module that is adapted to generate the simulated reality environment, to parse metadata in the multimedia content, and to create a priority score for the multimedia content based at least in part on predetermined rules and learned rules; and
an output module to display the simulated reality environment and the multimedia content in an order in the simulated reality environment based on the priority score for each of the multimedia content.

2. The system of claim 1, wherein the simulated reality environment is one of a VR environment, a mixed 2D and 3D environment, and an AR environment.

3. The system of claim 1, wherein the software application is at least one of an internet application and a mobile application.

4. The system of claim 1, wherein the importing module is further configured to sort the received multimedia content based on a date of receipt of the content.

5. A system for providing interactions between a plurality of user devices within a simulated reality environment, the system comprising:
a data store; and
a processor coupled to the data store, the processor being configured to execute:
an authorization module that is adapted to register an account for a first user device of the plurality of user devices, to receive access permission for the account from a simulated reality environment owner, and to identify visitation and content creation by the first user device, the content comprising at least one 3D object;
a data processing module that is adapted to synchronize interactions by the first user device with evolution pathways of the simulated reality environment, to share the interactions with the simulated reality environment owner and at least one of the plurality of user devices, and to collect a unique activation of the first user device and associated behaviors with at least one of a plurality of 3D objects in the simulated reality environment; and
an output module that is adapted to post multimedia messages and interactable objects to a central repository that influences the evolution pathways of the simulated reality environment.

6. The system of claim 5, wherein the simulated reality environment is one of a VR environment, a mixed 2D and 3D environment, and an AR environment.

7. The system of claim 5, wherein the output module is further adapted to send an invitation to at least one of the plurality of user devices with a custom-generated uniform resource locator or key-sensitive code.

8. The system of claim 7, wherein the output module is further adapted to create access permission to at least one of the plurality of user devices to the simulated reality environment.

9. The system of claim 5, wherein the processor is further configured to execute:
an environment state module that is adapted to monitor the interactions, determine time periods between the interactions, to identify relationships between users of at least two of the plurality of user devices, and to determine and generate data points based at least in part on the interactions, the time periods between the interactions, and the relationships;
an input module that is adapted to receive the data points; and
an auto-generation module that is adapted to learn by machine learning changes in placement and presentation of the content within the simulated reality environment, the machine learning based at least in part on a predefined set of rules with weighted distributions for the plurality of user devices, the relationships, and the data points.

10. The system of claim 9, wherein the machine learning is further based at least in part on:
extracting data relating to a location, a date/time, and identities of the plurality of user devices, the extracted data being obtained by an analysis of user submitted images, descriptions, and audio in the content;
obtaining user data from the plurality of user devices relating to the location, the date/time, and the identities of the plurality of user devices;
determining differences between the extracted data and the user data;
analyzing a first object of a plurality of 3D objects based at least in part on mesh, texture, and 2D representations, generating a plurality of tags based on the analysis and associating the first object to a real world location, a time period, other people, and categories;
grouping the extracted data and the user data, the grouping generating variables with assigned weights that determine how much similarity between different variables is needed for deciding whether or not to group content units together; and
searching among the plurality of 3D objects within a grouping for a 3D object that has extracted data most closely matching a combination of the user data and the extracted data to determine search results.

11. (canceled)

12. The system of claim 5, wherein the auto-generation module is further adapted to:
group the 3D objects by content unit;
group the content units by content group;
generate group 3D coordinates for each content group;
generate unit 3D coordinates for a content unit within a content group;
generate object 3D coordinates for each 3D object within a content unit; and
store in a database the group 3D coordinates, the unit 3D coordinates, the object 3D coordinates, and the 3D objects.

13. The system of claim 10, wherein the auto-generation module is further adapted to:
group the 3D objects by content unit;
group the content units by content group;
generate group 3D coordinates for each content group;
generate unit 3D coordinates for a content unit within a content group;
generate object 3D coordinates for each 3D object within a content unit; and
store in a database the group 3D coordinates, the unit 3D coordinates, the object 3D coordinates, the 3D objects, the extracted data, and the user data.

14.-17. (canceled)

18. A computer-implemented method for providing interactions between a plurality of user devices within a simulated reality environment, the method comprising:
registering an account for a first user device of the plurality of user devices;
receiving access permission for the account from a simulated reality environment owner;
identifying visitation and content creation by the first user device, the content comprising at least one 3D object;
synchronizing interactions by the first user device with evolution pathways of the simulated reality environment;
sharing the interactions with the simulated reality environment owner and at least one of the plurality of user devices;
collecting a unique activation of the first user device and associated behaviors with at least one of a plurality of 3D objects in the simulated reality environment; and
posting multimedia messages and interactable objects to a central repository that influences the evolution pathways associated with the simulated reality environment.

19. The method of claim 18, wherein the simulated reality environment is one of a VR environment, a mixed 2D and 3D environment, and an AR environment.

20. The method of claim 18, further comprising sending an invitation to at least one of the plurality of user devices with a custom-generated uniform resource locator or key-sensitive code.

21. The method of claim 20, further comprising creating access permission to at least one of the plurality of user devices to the simulated reality environment.

22. The method of claim 18, further comprising:
monitoring the interactions;
determining time periods between the interactions;
identifying relationships between users of at least two of the plurality of user devices;
determining and generating data points based at least in part on the interactions, the time periods between the interactions, and the relationships;
receiving the data points; and
learning by machine learning changes in placement and presentation of the content within the simulated reality environment, the machine learning based at least in part on a predefined set of rules with weighted distributions for the plurality of user devices, the relationships, and the data points.

23. The method of claim 22, wherein the machine learning is further based at least in part on:
extracting data relating to a location, a date/time, and identities of the plurality of user devices, the extracted data being obtained by an analysis of user submitted images, descriptions, and audio in the content;
obtaining user data from the plurality of user devices relating to the location, the date/time, and the identities of the plurality of user devices;
determining differences between the extracted data and the user data;
analyzing a first object of a plurality of 3D objects based at least in part on mesh, texture, and 2D representations, generating a plurality of tags based on the analysis and associating the first object to a real world location, a time period, other people, and categories;
grouping the extracted data and the user data, the grouping generating variables with assigned weights that determine how much similarity between different variables is needed for deciding whether or not to group content units together; and
searching among the plurality of 3D objects within a grouping for a 3D object that has extracted data most closely matching a combination of the user data and the extracted data to determine search results.

24. (canceled)

25. The method of claim 18, further comprising:
grouping the 3D objects by content unit;
grouping the content units by content group;
generating group 3D coordinates for each content group;
generating unit 3D coordinates for a content unit within a content group;
generating object 3D coordinates for each 3D object within a content unit; and
storing in a database the group 3D coordinates, the unit 3D coordinates, the object 3D coordinates, and the 3D objects.

26. The method of claim 23, further comprising:
grouping the 3D objects by content unit;
grouping the content units by content group;
generating group 3D coordinates for each content group;
generating unit 3D coordinates for a content unit within a content group;
generating object 3D coordinates for each 3D object within a content unit; and
storing in a database the group 3D coordinates, the unit 3D coordinates, the object 3D coordinates, the 3D objects, the extracted data, and the user data.
